(19) United States
(12) Patent Application Publication
(10) Pub. No.: US 2025/0259165 A1
(43) Pub. Date: Aug. 14, 2025

(54) PRE-AUTHORIZED TRANSACTION IN COLD CRYPTOGRAPHIC KEY STORAGE

(71) Applicant: Blockdaemon Inc., Los Angeles, CA (US)

(72) Inventors: Vincent Kobel, Geneva (CH); Alexandre Karlov, Crans (VD) (CH); Jakob Pagter, Aarhus (DK)

(21) Appl. No.: 19/040,583

(22) Filed: Jan. 29, 2025

Related U.S. Application Data
(60) Provisional application No. 63/553,514, filed on Feb. 14, 2024.

(51) Int. Cl. G06Q 20/38; G06Q 20/40; H04L 9/08

(52) U.S. Cl. CPC G06Q 20/3829; G06Q 20/401; H04L 9/0825

(57) ABSTRACT

A system may store, in an offline storage, a private cryptographic key that corresponds to a public cryptographic key that corresponds to a blockchain address of a blockchain. The system may connect temporarily to the offline storage to generate one or more pre-authorized transaction requests using the private cryptographic key stored in the offline storage. The system may disconnect the offline storage from the computing device. The system may store the one or more pre-authorized transaction requests in the computing device, wherein the one or more pre-authorized transaction requests include pre-determined parameters such that the one or more pre-authorized transaction requests are broadcastable to the blockchain without further retrieving the private cryptographic key stored in the disconnected storage.

### CROSS-REFERENCE TO RELATED APPLICATION(S)

The present application claims the benefit of U.S. Provisional Patent Application No. 63/553,514, filed on Feb. 14, 2024, which is hereby incorporated by reference in its entirety.

### FIELD

The disclosure generally relates to the architecture of pre-authorization of transactions in using an offline cryptographic key storage system.

### BACKGROUND

In an interconnected digital landscape, cybersecurity threats continue to evolve and become more sophisticated. To improve cybersecurity, enterprises are adopting various secure infrastructures. Oftentimes enterprises rely on features provided by cybersecurity companies and cloud computing that offers enhanced security features to set up secure infrastructures. This shift toward secure cloud-based solutions allows enterprises to offload the responsibility of maintaining complex security measures to specialized providers. Cloud providers now may provide a ready-to-use secure environment for an enterprise to run various processes. While the secure environment is proof against many known threats, the delivery of content to the secure environment may still be a point of vulnerability. For example, a malicious party may have tampered with content before the content is delivered to a secure environment.

In addition, a conventional secure environment is managed by one or more administrators of an enterprise who may have the access privilege of the secure environment. Even though the secure environment may be equipped with state-of-the-art security measures, the administrators may have sufficient privilege to obtain the entire memory content of the secure environment. This may shift the vulnerability from the secure environment to the devices possessed by the administrator. In some cases, the cloud service provider may be a vulnerability source, as the cloud service provider may be in control of the underlying infrastructure that executes the enterprise's operations.

### SUMMARY

In some embodiments, the techniques described herein relate to a system including: an offline storage configured to store a private cryptographic key that corresponds to a public cryptographic key that corresponds to a blockchain address of a blockchain; and a computing device including memory and one or more processors, the memory storing executable instructions, wherein the instructions, when executed by the one or more processors, cause the one or more processors to: connect temporarily to the offline storage to generate one or more pre-authorized transaction requests using the private cryptographic key stored in the offline storage; disconnect the offline storage from the computing device; and store the one or more pre-authorized transaction requests in the computing device, wherein the one or more pre-authorized transaction requests include pre-determined parameters such that the one or more pre-authorized transaction requests are broadcast-able to the blockchain without further retrieving the private cryptographic key stored in the disconnected storage.

In some embodiments, the techniques described herein relate to a system, wherein the one or more pre-authorized transaction requests includes a staking request to stake a predefined quantity of a blockchain unit to the blockchain.

In some embodiments, the techniques described herein relate to a system, wherein the pre-determined parameters include (1) a nonce that is a counter specific to the blockchain address, (2) a recipient address, and (3) a predefined quantity of a blockchain unit.

In some embodiments, the techniques described herein relate to a system, wherein the one or more pre-authorized transaction requests includes an unstaking request that requests a quantity of blockchain unit be returned to the blockchain address corresponding to the public cryptographic key.

In some embodiments, the techniques described herein relate to a system, wherein the offline storage is part of an offline multi-party computation node.

In some embodiments, the techniques described herein relate to a system, wherein at least one of the pre-authorized transaction requests is separated into multiple shards that are stored in multi-party computation nodes.

In some embodiments, the techniques described herein relate to a system, wherein at least one of the pre-authorized transaction requests is stored by the computing device in an encrypted form.

In some embodiments, the techniques described herein relate to a system, wherein the offline storage is disconnected permanently from the Internet.

In some embodiments, the techniques described herein relate to a system, wherein generating one or more pre-authorized transaction requests include: generating two or more alternative versions of transaction requests that correspond to the same nonce.

In some embodiments, the techniques described herein relate to a system, further including: a blockchain node configured to receive a quantity of blockchain unit and broadcast, in response to receiving the quantity, one of the pre-authorized transaction requests to the blockchain without further retrieving the private cryptographic key.

In some embodiments, a non-transitory computer-readable medium that is configured to store instructions is described. The instructions, when executed by one or more processors, cause one or more processors to perform a process that includes steps described in the above computer-implemented methods or described in any embodiments of this disclosure. In some embodiments, a system may include one or more processors and memory coupled to the processors that are configured to store instructions. The instructions, when executed by one or more processors, cause the one or more processors to perform a process that includes steps described in the above computer-implemented methods or described in any embodiments of this disclosure.

### BRIEF DESCRIPTION OF THE DRAWINGS

FIG. 1 is a block diagram that illustrates a system environment of a multi-party computation execution environment, in accordance with some embodiments.

FIG. 2 is a block diagram representing an example computing server, in accordance with some embodiments.

FIG. 3 is a block diagram representing an example on-premises node, in accordance with some embodiments.

FIG. 4 is a conceptual block diagram illustrating a multi-party computation architecture, in accordance with some embodiments.

FIG. 5 is a flowchart depicting a process for generating pre-authorized transaction requests, in accordance with some embodiments.

FIG. 6A is a block diagram illustrating a chain of transactions broadcasted and recorded on a blockchain, in accordance with some embodiments.

FIG. 6B is a block diagram illustrating a connection of multiple blocks in a blockchain, in accordance with some embodiments.

FIG. 7 is a block diagram illustrating components of an example computing machine that is capable of reading instructions from a computer-readable medium and executing them in a processor (or controller).

The figures depict, and the detailed description describes, various non-limiting embodiments for purposes of illustration only.

### DETAILED DESCRIPTION

The figures (FIGS.) and the following description relate to preferred embodiments by way of illustration only. One of skill in the art may recognize alternative embodiments of the structures and methods disclosed herein as viable alternatives that may be employed without departing from the principles of what is disclosed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### System Overview

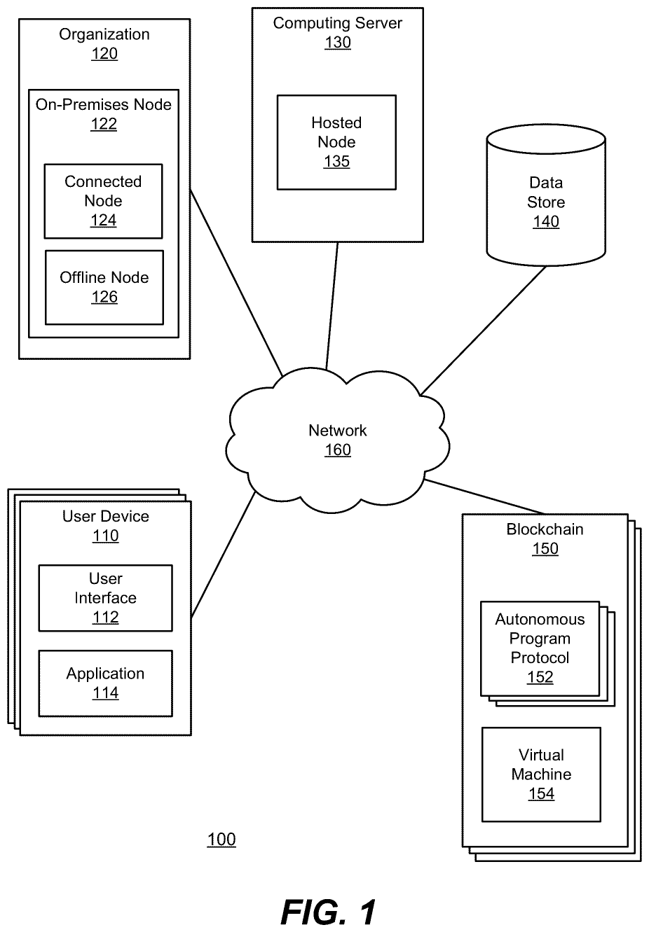

FIG. (FIG. 1 is a block diagram that illustrates a system environment 100 of an example execution environment, in accordance with some embodiments. By way of example, the system environment 100 includes a user device 110, an organization 120 that hosts on-premises nodes 122, a computing server 130 that may provide a hosted node 135, a data store 140, a blockchain 150 that has one or more autonomous program protocols 152 stored on the blockchain 150. The entities and components in the system environment 100 communicate with each other through network 160. In various embodiments, the system environment 100 may include different, fewer, or additional components. The components in the execution environment 100 may each correspond to a separate and independent entity or may be controlled by the same entity. For example, in some embodiments, the computing server 130 may control the data store 140, but, in other embodiments, the computing server 130 and the data store 140 are operated by different entities. Likewise, the computing server 130 and the organization 120 can be different entities. While this disclosure uses blockchain operations as an example of an application of operations, various embodiments do not necessarily have any connection with the use of blockchains. The architecture described herein may have wide applications in computer security, data encryption, digital signature, privacy-preserving data analysis, fraud detection, cybersecurity, and secure computing outsourcing. The architecture may also be used in industry or usage-specific applications, such as secure voting, financial transactions, contract signing, etc.

While each of the components in the system environment 100 is sometimes described in disclosure in a singular form, the system environment 100 may include one or more of each of the components. For example, there can be multiple user devices 110 communicating with the computing server 130 and various blockchain management nodes, such as the on-premises nodes 122 and hosted nodes 135. The organization 120 may typically host more than one on-premises node 122. The computing server 130 may provide service for multiple organizations 120, each of which has its own on-premises nodes 122 that are implemented as MPC nodes and multiple users who may operate different user devices 110. While a component is described in a singular form in this disclosure, it should be understood that in various embodiments, the component may have multiple instances. Hence, in the system environment 100, there can be one or more of each of the components. Likewise, while some of the components are described in a plural form may also only have a single instance in the system environment 100 in some embodiments.

A user device 110 may also be referred to as a client device. A user device 110 may be controlled by a user who may be the user of the computing server 130, the on-premises node 122, or the hosted node 135. In some situations, a user may also be referred to as an end user, for example, when the user is the organization's customer who uses a software application that is published by the organization 120. In some situations, various users may be employees of the organization 120 and perform blockchain operations under the policies of the organization 120. The user device 110 may be any computing device. Examples of user devices 110 include personal computers (PC), desktop computers, laptop computers, tablet computers, smartphones, wearable electronic devices such as smartwatches, or any other suitable electronic devices.

Blockchain operations may be any suitable operations related to blockchains 150 such as operations that are carried out on a blockchain 150 or by an autonomous program protocol 152 of the blockchain 150. Examples of blockchain operations include cryptocurrency or token transactions, causing issuance of a token to a user, staking on a blockchain 150, invoking one or more algorithms of an autonomous program protocol 152, feeding data to an autonomous program protocol 152 through an oracle machine, performing mining or minting in a blockchain 150, participating in a blockchain 150 as a blockchain node, etc. In various situations, blockchain operations may be used interchangeably with blockchain transactions. A blockchain operation may involve using an organization's private cryptographic key to generate a signature as proof of ownership of an organization's blockchain asset. The private cryptographic key may be divided and stored as key shards that are respectively stored in different MPC nodes.

In some embodiments, there can be different types of users within an organization 120 in the setting of performing a blockchain operation, depending on the roles of the users in various operations. For example, in a multi-party authorization (MPA) setting for conducting an operation, one user may be an initiator, and one or more other users may be approvers. The roles of initiator and approvers may change based on the identity of the initiator, the employee hierarchy of organization 120, and the policies set forth by organization 120. A user may also be an administrator of organization 120 who is responsible for working with the computing server 130 to manage various settings and parameters of one or more nodes of organization 120.

A user in the system environment 100 may sometimes also be referred to as a named entity. A named entity may represent a user themselves, such as an employee of an organization 120. In some embodiments, a named entity may also be a team, a department, a vendor, a contractor, or another unit of the organization 120. A user in this context may refer to the user themselves or an administrator of the named entity who takes the role of managing the named entity. An organization 120 may maintain a hierarchy of named entities, which contains information about the relationships among the named entities. In the case of an authorization policy situation, such as in an MPA, the hierarchy of the named entities may be used to determine a chain of authorization required to approve an operation. For example, a policy may specify that a transaction over a certain amount from an employee requires the employee's manager's approval.

A user device 110 may include a user interface 112 and an application 114. The user interface 112 may be the interface of the application 114 and allow the user to perform various actions associated with application 114. For example, application 114 may be a software application, and the user interface 112 may be the front end. The user interface 112 may take different forms. In one embodiment, the user interface 112 is a software application interface. For example, a business may provide a front-end software application that can be displayed on a user device 110. In one case, the front-end software application is a software application that can be downloaded and installed on a user device 110 via, for example, an application store (App store) of the user device 110. In another case, the front-end software application takes the form of a webpage interface of the organization 120 that allows clients to perform actions through web browsers. The front-end software application includes a graphical user interface (GUI) that displays various information and graphical elements. For example, the GUI may be the web interface of a software-as-a-service (SaaS) platform that is rendered by a web browser. In some embodiments, user interface 112 does not include graphical elements but communicates with a server or a node via other suitable ways, such as command windows or application program interfaces (APIs).

In system environment 100, multiple different types of applications 114 may be operated on a user device 110. Those applications 114 may be published by different entities and be in communication with different components in the system environment 100. For example, in some embodiments, a first application 114 may be a software application that is published by the organization 120 for the employees of the organization 120 to perform work-related tasks. In some embodiments, a second application 114 may be a blockchain wallet frontend application that is published by the computing server 130 (or managed by an organization 120) for a user to communicate with the on-premises node 122. In some embodiments, a third application 114 may be a software application for a user to communicate to a blockchain node, which may be a hosted node 135, for the user to gain information about a blockchain 150 or perform a blockchain operation. In some embodiments, a fourth application 114 may be a SaaS platform hosted by the computing server 130 as a web application for an administrator of an organization 120 to manage one or more nodes provided by the computing server 130. These are merely examples of various types of applications 114 that may be operated on a user device 110.

An organization 120, such as an enterprise, may be a customer of the computing server 130 and use different components, products, and services offered or managed by the computing server 130. For example, an organization 120 may install one or more on-premises nodes 122 that are provided by and in communication with the computing server 130. In some embodiments, the organization 120 may also use one or more hosted nodes 135 that may be hosted by the computing server 130. The on-premises node 122 and hosted node 135 are blockchain-related nodes that may be used to perform one or more blockchain operations. Depending on the organization's choice, a multi-node system, such as a multiple-party computation (MPC) system, may use only on-premises nodes 122 that are managed by the organization, a mix of on-premises nodes 122 and hosted nodes 135, and only hosted nodes 135.

An organization 120 may set forth one or more policies specifying the authentication and authority requirements for various employees in conducting blockchain operations through the organization 120. The organization 120 may use various products and services provided by the computing server 130 to manage digital assets, maintain private cryptographic keys for blockchain wallets, such as through multi-party computation provided by the functionalities of a node, operate a wallet system, perform multi-party authorization for operations, and enforce policies set forth by the organization 120. In some embodiments, an organization 120 may delegate one or more tasks (e.g., key management, operation authorization, policy enforcement) to the computing server 130 by using one or more nodes provided by the computing server 130 and/or directly communicating with the computing server 130.

An organization 120 may also be referred to as a domain. In some embodiments, the terms domain and organization may be used interchangeably. A domain refers to an environment for a group of units and individuals to operate and use domain knowledge to organize activities, enforce policies, and operate in a specific way. An example of a domain is an organization, such as a business, an institute, or a subpart thereof, and the data within it. A domain can be associated with a specific domain knowledge ontology, which could include representations, naming, definitions of categories, properties, logics, and relationships among various concepts, data, transactions, and entities that are related to the domain. The boundary of a domain may not completely overlap with the boundary of an organization. For example, a domain may be a subsidiary of a company. Various divisions or departments of the organization may have their own definitions, internal procedures, tasks, and entities. In other situations, multiple organizations may share the same domain.

An on-premises node 122 may be a node initially provided or designed by the computing server 130 but may be deployed and hosted on-premises in an organization 120 and controlled by the organization 120. The functionalities of an on-premises node 122 may vary depending on the embodiments. For example, in some embodiments, the on-premises node 122 may have sufficient functionalities to serve as a fully functional blockchain node of a blockchain 150. Yet, in other embodiments, one or more functionalities of an on-premises node 122 may still partially rely on the computing server 130. For example, the on-premises node 122 and the computing server 130 may cooperatively manage one or more private cryptographic keys of the users of the organization 120 through MPC, and both the on-premises node 122 and computing server 130 may serve as nodes in the MPC. In some embodiments, the on-premises nodes 122 are solely managed by the organization 120, and the private cryptographic keys of the organization 120 are split as key shards and separately stored in multiple on-premises nodes 122 so that the computing server 130 is not involved in the day-to-day management of the on-premises nodes except in the initial deployment and updates of features. In some embodiments, an on-premises node 122 may operate in a secure environment within the organization 120 so that the on-premises node 122 is not generally accessible by a public network such as the Internet. In such cases, the on-premises node 122 may be in communication with the computing server 130 and route certain blockchain operation requests to the computing server 130 for performing the operation. The functionalities of the blockchain node may reside in the computing server 130.

The on-premises node 122 may work with the computing server 130 to carry out a blockchain operation. For instance, in carrying out certain blockchain operations, the on-premises node 122 may first route an operation intent that includes the parameters of the operation to the computing server 130. In turn, the computing server 130, based on the current condition of the blockchain 150, may generate a draft of an operation payload that reflects the intent. The operation payload is the payload that is used to carry out the operation. The operation payload may sometimes also be referred to as a broadcast payload because it can be a payload that is used to broadcast to a blockchain 150. The computing server 130 may transmit the operation payload back to the on-premises node 122, which in turn decodes the payload and verifies that the parameters as reflected in the payload still match those in the original intent. The on-premises node 122 may ask a user device 110 to approve the payload or multiple user devices 110 to approve the payload in case of multi-party authorization. Upon proper approval, the payload may be signed and routed to the computing server 130 for broadcasting to the blockchain 150.

An on-premises node 122 may be a node that is managed and operated directly by the organization 120. For example, an on-premises node 122 may be run on devices that are controlled by the organization 120. In some embodiments, the on-premises node 122 may be operated by one or more servers of the organization 120. However, the use of a server is not a requirement. An on-premises node 122 may be operated in any device of the organization 120, such as a user device 110 of an employee of the organization 120. In another example, even though the node is described as “on-premises,” the nodes may be hosted on common cloud service providers where the organization 120 is in control of the accounts managing the cloud service. As such, an on-premises node 122 does not have to reside in a device that is physically located on the premises of the offices or other physical locations of the organization 120. In some embodiments, on-premises in this context merely refers to the on-premises node 122 being managed and controlled by the organization 120. In some cases, the device operating an on-premises node 122 may be a mobile device whose physical location is not fixed. In some embodiments, an on-premises node 122 is subject to one or more security requirements set forth by an organization 120.

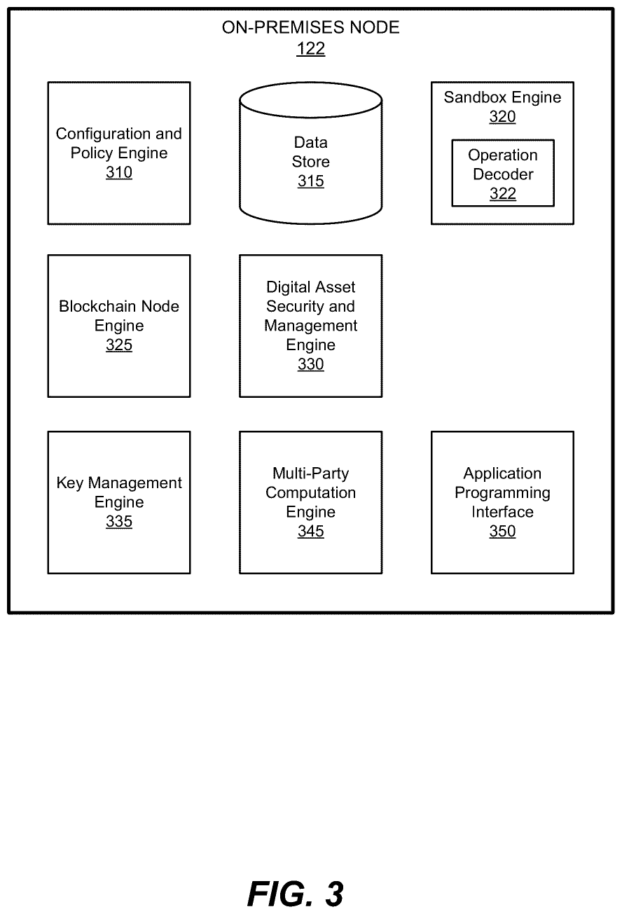

In some embodiments, the computing server 130 may provide a software marketplace (e.g., similar to an App store) through a digital distribution platform so that an organization 120 may add additional software components to the on-premises node 122 to expand the functionalities of the on-premises node 122. In some embodiments, each software component may be modularized so that the software component may be added and updated without affecting the system files or other software components of the on-premises node 122. One example of a software component that may be added to the on-premises node 122 is a sandbox that may operate in a secure environment and simulate the operation of a blockchain 150. The sandbox environment may be written in a language such as WEBASSEMBLY (WASM). The details of the operations and sub-components of an example on-premises node 122 will be further discussed in association with FIG. 3.

In this disclosure, a node may generally refer to a worker on a larger network (e.g., a distributed computing network) of computers that may work together to perform a task. A worker may take the form of a computing device, a virtual machine, or any computing component that has processing power, memory, and storage. A node may execute a task independently, distributively, or jointly with other nodes. An MPC node is one of the nodes performing an MPC operation. A blockchain node is a specific kind of node that participates in a blockchain network 150. A blockchain node may be a validator node that participates in the validation and processing of operations on the blockchain 150. Depending on the sub-type of a blockchain node, some blockchain nodes may store a copy of the entire blockchain ledger, while other nodes may only store a partial copy of the ledger. In some embodiments, the on-premises node 122 and hosted node 135 are nodes that are related to carrying out operations in blockchains and may be referred to as blockchain-related nodes. Blockchain-related nodes and blockchain nodes are different terms in this disclosure. A blockchain-related node may or may not have the full functionality to be compliant with the protocol of a blockchain 150 to serve as a blockchain node. Depending on the functionalities of a node in various embodiments, an on-premises node 122 or a hosted node 135 may include sufficient functionalities to serve as a blockchain node of a blockchain 150.

In some embodiments, the on-premises nodes 122 may include a connected node 124 and an offline node 126. In some embodiments, the organization 120 may operate one or more connected nodes 124 and one or more offline nodes 126. A connected node 124 is a node that is connected to the network 160 such as the Internet and may be referred to as a hot node, a hot storage, or a hot wallet. A connected node 124 is able to communicate directly to the rest of the organization and the network 160 directly through any suitable network connection. As such, a connected node 124 may be referred to a node that is online. A connected node 124 may provide a wallet application function and store a private cryptographic key, or a shard thereof, associated with a blockchain address. In this situation, the connected node 124 may be referred to as a hot wallet because transactions may be signed almost instantaneously and broadcasted to a blockchain 150.

An offline node 126 is a node that is disconnected from the network 160 and is typically not discoverable through the Internet. For example, an offline node 126 may be disconnected permanently from the Internet. An offline node 126 may be referred to as an offline device, an offline storage, a cold node, a cold storage, or a cold wallet. An offline node 126 usually stores cold data, such as a cold private cryptographic key, or a shard thereof, which may be referred to data that is expected to be inactive or less frequently accessed. In some embodiments, an offline node 126 is isolated from the rest of the network of the organization 120 and isolated from the Internet. An offline node 126 may be physically located at a secured location such as a vault so that a retrieve of data from the offline node 126 would require a person physically travelling to the location of offline node 126. An offline node 126 provides extra security to the data stored. For example, a blockchain address may correspond to a public cryptographic key that is generated by a private cryptographic key. The private cryptographic key may be stored in an offline node 126. This provides extra security to safeguard the private cryptographic key because the malicious party will not be able to hack into the offline node 126 to obtain the private cryptographic key because the offline node 126 is disconnected from a public network such as the Internet. However, conducting transactions with a private cryptographic key that is stored in the offline node 126 increases the cost of transactions and slow down the transactions because the private cryptographic key will need to be manually retrieved by a person travelling to the physical location of the offline node 126 to generate signatures for the transactions.

Various types of nodes in this disclosure may be part of an MPC system and serve as the nodes for the MPC system. As such, for the nodes that participate in the MPC system may be referred to as MPC nodes. In some embodiments, an organization 120 may maintain a connected MPC system that involves one or more connected nodes 124 and/or one or more hosted nodes 135. In some embodiments, organization 120 may also maintain an offline MPC system that involves solely one or more offline nodes 126. A private cryptographic key that is stored in an offline storage may be stored entirely within an offline node 126 or the private cryptographic key may be divided into shards and the shards are distributed among the offline MPC nodes. In either case, the private cryptographic key is considered being stored in an offline storage.

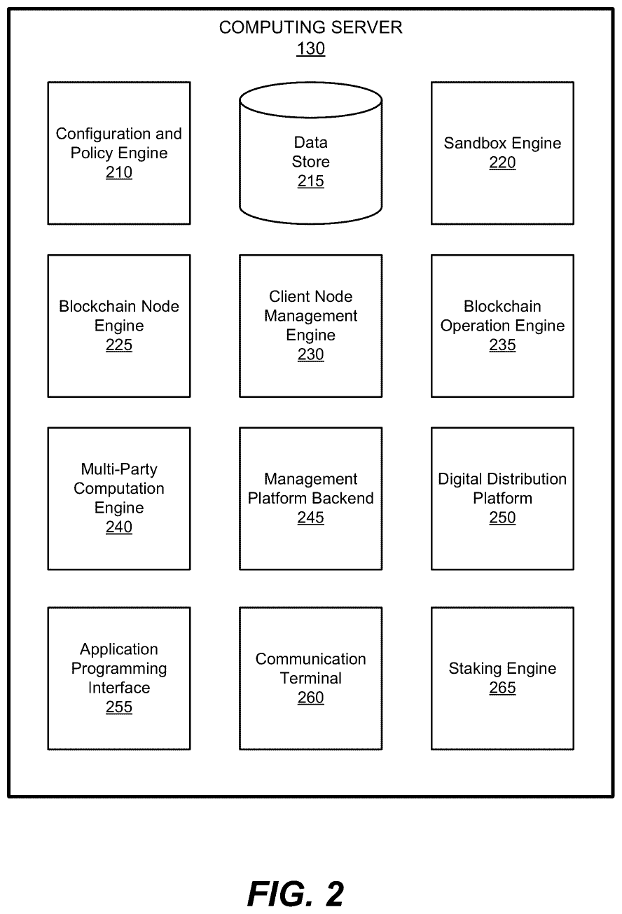

A computing server 130 may be a server that provides functionalities and services to organization customers for managing various MPC nodes and blockchain-related nodes, providing API for data of blockchains 150, deploying MPC nodes to organizations 120, providing access control features for an organization 120 to manage access to a blockchain-based on policies of the organization 120, and other blockchain-related services. The computing server 130 may also be referred to as a remote server. While the computing server 130 is referred to as a server, for simplicity, the computing server 130 may also encompass the company that operates the computing server 130. Hence, the computing server 130 described herein may refer to a business. The services provided by the computing server 130 may include access control, operation verification, sandbox environment, blockchain node, authentication, authorization, and other suitable compliance (e.g., Know Your Customers KYC) services. The details of the operations and sub-components of the computing server 130 will be further discussed in association with FIG. 2.

While the computing server 130 is described in a singular form, the computing server 130 may include one or more computers that operate independently, cooperatively, and/or distributively. For example, in various embodiments, the computing server 130 may take different suitable forms. In some embodiments, the computing server 130 may be a server computer that includes one or more processors and memory that stores code instructions that are executed by the one or more processors to perform various processes described herein. In some embodiments, the computing server 130 may be a pool of computing devices that may be located at the same geographical location (e.g., a server room) or be distributed geographically (e.g., cloud computing, distributed computing, or in a virtual server network). In some embodiments, the computing server 130 may be a collection of servers that independently, cooperatively, and/or distributively provide various products and services described in this disclosure. The computing server 130 may also include one or more virtualization instances such as a container, a virtual machine, a virtual private server, a virtual kernel, or another suitable virtualization instance. The computing server 130 may provide organizations 120 with various blockchain services in the form of nodes in addition to cloud-based software, such as software as a service (SaaS), through the network 160.

A hosted node 135 may be a node that is hosted by the computing server 130 for performing blockchain-related services on behalf of an organization 120. For example, a hosted node 135 may be a node that is dedicated to an organization 120. The computing server 130 may provide a management platform, such as a SaaS platform, for an organization 120 to manage the preferences and parameters of the hosted node 135 while the hosted node 135 is operated by the computing server 130. In some embodiments, the functionalities of a hosted node 135 may be similar to those of an on-premises node 122. An on-premises node 122 may provide full control and a higher level of security for an organization 120, while a hosted node 135 may be more flexible in terms of upgrades and updates and also delegate the operation of a node to the computing server 130. An organization 120, depending on its needs and situations, may select to use only on-premises nodes 122, a mix of on-premises nodes 122 and hosted nodes 135, or only hosted nodes 135. For example, in some embodiments, an MPC system may include a mix of on-premises nodes and hosted nodes 135.

The data store 140 includes one or more storage units, such as memory, that takes the form of a non-transitory and non-volatile computer storage medium to store various data. The computer-readable storage medium is a medium that does not include a transitory medium, such as a propagating signal or a carrier wave. The data store 140 may be used by the computing server 130 to store data related to the computing server 130, such as policies of various organizations 120, parameters of various nodes, and other information related to various blockchains 150. In one embodiment, the data store 140 communicates with other components by the network 160. This type of data store 140 may be referred to as a cloud storage server. Examples of cloud storage service providers may include AMAZON AWS, DROPBOX, RACKSPACE CLOUD FILES, AZURE, GOOGLE CLOUD STORAGE, etc. In another embodiment, instead of a cloud storage server, the data store 140 is a storage device that is controlled and connected to the computing server 130. For example, the data store 140 may take the form of memory (e.g., hard drives, flash memory, discs, ROMs, etc.) used by the computing server 130, such as storage devices in a storage server room that is operated by the computing server 130.

A blockchain 150 may be a public blockchain that is decentralized, a private blockchain, a semi-public blockchain, an execution layer settling data on a public blockchain (e.g., Layer 2 blockchains, rollups), or an application-specific chain. A blockchain 150 may include a ledger that records transactions, code instructions, and other information associated with various blockchain addresses. A blockchain network includes a plurality of blockchain nodes that cooperate to verify transactions and generate new blocks. In some implementations of a blockchain, the generation of a new block may also be referred to as a proposal process that is based on a consensus mechanism, which may be a mining process (e.g., proof of work) or a validation process (e.g., proof of stake). A blockchain 150 may be a new blockchain or an existing blockchain such as BITCOIN, ETHEREUM, EOS, NEAR, SOLANA, AVALANCHE, etc. The system environment 100 may include one or more blockchains 150. A blockchain 150 includes a plurality of blockchain nodes. Each blockchain node may include one or more processors. The processors in various nodes may independently or cooperatively execute various blockchain processes such as generating blocks, reaching consensus, and executing code instructions that are stored on the blockchain 150.

A blockchain address may correspond to a public cryptographic key that is generated by a private cryptographic key. The private cryptographic key may be securely and secretly held by the account holder of the blockchain address. The blockchain address may correspond to the public cryptographic key in various ways based on the specification of the blockchain 150. For example, in some embodiments for some blockchains 150, the public cryptographic key is the blockchain address. In some embodiments, certain prefixes and suffixes are added to public cryptographic key to generate the blockchain address. In some embodiments, the public cryptographic key is passed through certain deterministic algorithm (such as known cipher or scramble algorithm) to generate the blockchain address. The holder of the private cryptographic key will be able to prove that the holder is also the owner of the blockchain address.

Some of the blockchains 150 support autonomous program protocol 152, which is a set of code instructions that are stored on a blockchain 150 and are executable when one or more conditions are met. Examples of autonomous program protocols 152 include token contracts, smart contracts, Web3 applications, autonomous applications, distributed applications, decentralized applications (dApps), decentralized finance (DeFi) applications, protocols for decentralized autonomous organizations (DAOs), protocols that generate non-fungible tokens (NFTs), decentralized exchanges, blockchain gaming, metaverse protocols, and other suitable protocols and algorithms that may be recorded on a blockchain. Smart contracts may be examples of autonomous program protocols 152 that may be executable by a computer such as a virtual machine 154 of the blockchain 150. Here, a computer may be a single operation unit in a conventional sense (e.g., a single personal computer), a resource of the blockchain such as a virtual machine 154, or a set of distributed computing devices that cooperate in executing the code instructions (e.g., a distributed computing system). An autonomous program protocol 152 includes a set of instructions. The instructions, when executed by one or more processors, cause one or more processors to perform steps specified in the instructions. The processors may correspond to a blockchain node of the blockchain 150 or may be distributed among various nodes of the blockchain 150.

A virtual machine 154 is a resource unit of a blockchain 150. A virtual machine 154 may be a standardized software execution environment that emulates the functionality of a physical machine and allows for the execution of autonomous program protocol 152 on the virtual machine 154. A virtual machine 154 may be run by any blockchain node. In some embodiments, a virtual machine 154 may take the form of a sandboxed environment that is created within the blockchain network to execute autonomous program protocol 152. The autonomous program protocols 152 are compiled into bytecode that can be executed by the virtual machine. One example of the virtual machine 154 Ethereum Virtual Machine (EVM) that executes the programming language SOLIDITY. In some embodiments, a virtual machine 154 may operate based on binary instruction language such as WEBASSEMBLY that can be executed in a variety of environments, such as web browsers. An example of such a virtual machine 154 is Ethereum WebAssembly (EWASM) which may allow programmers to build autonomous program protocols 152 using various common programming languages.

The communications among a user device 110, an organization 120, the computing server 130, a hosted node 135, and the blockchain 150 may be transmitted via a network 160. The network 160 may be a public network such as the Internet. In one embodiment, the network 160 uses standard communications technologies and/or protocols. Thus, the network 160 can include links using technologies such as Ethernet, 802.11, worldwide interoperability for microwave access (WiMAX), 3G, 4G, LTE, 5G, digital subscriber line (DSL), asynchronous transfer mode (ATM), InfiniBand, PCI Express Advanced Switching, etc. Similarly, the networking protocols used on the network 160 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 160 can be represented using technologies and/or formats, including the hypertext markup language (HTML), the extensible markup language (XML), etc. In addition, all or some of the links can be encrypted using conventional encryption technologies such as secure sockets layer (SSL), transport layer security (TLS), virtual private networks (VPNs), Internet Protocol security (IPsec), etc. The network 160 also includes links and packet-switching networks such as the Internet.

### Example Computing Server

FIG. 2 is a block diagram representing an example computing server 130, in accordance with some embodiments. In the embodiment shown in FIG. 2, the computing server 130 includes configuration and policy engine 210, data store 215, sandbox engine 220, blockchain node engine 225, client node management engine 230, blockchain operation engine 235, multi-party computation engine 240, management platform backend 245, digital distribution platform 250, application programming interface (API) 255, communication terminals 260, and a staking engine 265. The functions of the computing server 130 may be distributed among different components in a different manner than described below. Also, in various embodiments, the computing server 130 may include different, fewer, and/or additional components.

While the computing server 130 is used in a singular form, the computing server 130 may include one or more computers that include one or more processors and memory. The memory may store computer code that includes instructions. The instructions, when executed by one or more processors, cause the processors to perform one or more processes described herein. The computing server 130 may take different forms. In some embodiments, the computing server 130 is a single computer that executes code instructions directly. In some embodiments, the computing server 130 is a group of computing devices that communicate with each other. The computing devices may be located geographically at the same (e.g., in a server room) or in different locations. In some embodiments, the computing server 130 includes multiple nodes that operate in a distributed fashion such as in cloud computing or distributed computing. Each node may include one or more computing devices operating together. In some cases, the computing server 130 may also include virtual machines. In some embodiments, each component in FIG. 2 may be operated by a separate server and the computing server 130 may serve as the collective term of those servers. Any computing devices, nodes, or virtual machines, singular or plural, may simply be referred to as a computer, a computing device, or a computing server. Components of the computing server 130 shown in FIG. 2, individually or in combination, may be a combination of hardware and software and may include all or a subset of the example computing system illustrated and described in FIG. 9.

In some embodiments, the configuration and policy engine 210 may store and determine policy rules for various participants in an organization 120 for the use of organizational resources to conduct operations, such as blockchain operations. A policy may be defined by an organization 120 or automatically added or defined by the computing server 130 based on certain default settings. An organization 120 may transmit the policy set to, or build the policy at, a policy management platform (e.g., a SaaS platform) operated by the computing server 130. The configuration and policy engine 210 translates the policy to suitable parameters, conditions, and triggers that are maintained by the computing server 130. The policies may be of different suitable natures, such as requirements related to authentication, identity verification, authorization, access control, and compliance. Based on the policies specified by an organization 120, the computing server 130 may adjust one or more nodes (e.g., an on-premises node 122 and a hosted node 135) for the organization 120 to provide authorization requirements, security, protection and access control to a blockchain 150, such as an autonomous program protocol 152 recorded on the blockchain 150. An organization 120 may specify one or more access control settings that define various criteria for completing operations with an autonomous program protocol 152. For example, the access control settings may define who can gain access to an autonomous program protocol 152 and the manner in which a party may access the autonomous program protocol 152. The settings may define authorization and an access control list that may be specific to a blockchain 150, an autonomous program protocol 152, a transaction amount, and/or an operation type. For example, a policy of an organization 120 may specify an approval process for performing certain operations as may be defined by the organization 120 as sensitive, such as adding a user, staking in a blockchain 150, transferring cryptocurrency, etc. The policy may define a threshold requirement for an initiator to initiate the operation and an approval flow for the operation, such as a multi-party authorization workflow that requires one or more approvers to authorize the operation.

A policy may be generic or specific. A specific policy may be a policy that is customized by an organization 120 and is specific to a certain named entity, a type of operation, a transaction threshold, and/or another criterion. A specific policy defines a specific rule with respect to an operation that meets certain criteria. For example, an organization 120 may define a multi-party authorization workflow that requires a manager to approve an employee's initiation of an operation that is categorized by the organization 120 as sensitive. In contrast, a generic policy may be a policy that is commonly applied to many operations, such as a threshold amount for transactions that exceed the threshold. The configuration and policy engine 210 may include or suggest default rules for a generic policy and may enforce a generic policy for various autonomous program protocols 152 based on the selections of an organization 120. A policy may also preapprove an operation based on certain conditions, require authorization before an operation is approved, and/or impose certain reporting requirements after the operation is carried out. A policy may also be ruled-based or dynamic. For example, a policy may be carried out by a machine learning model that does not have a very specific and fixed rule for defining a policy.

In some embodiments, policies may be cryptographically enforced. In some embodiments, blockchain operations are signed as policy compliant after the applicable policies have been enforced. Operation approvals can be conducted using programmatic APIs, manual approvers, or a combination of both. In some embodiments, an organization 120 may specify policies and associated conditions through a user-friendly platform provided by the computing server 130. The configuration and policy engine 210 translates the policies to the appropriate parameters and conditions and transmits the policies to an on-premises node 122 for the policy to be cryptographically enforced. In some embodiments, the policies may be stored on-premises of the organization 120 as discussed in further detail below in association with the configuration and policy engine 310 operated by the on-premises node 122.

In some embodiments, the data store 215 is a database that stores various information with respect to settings provided by customers of the computing server 130, such as organizations 120. The data stored may include profiles of organization customers, named entity hierarchies of organizations 120, node settings of the customers, and various policies associated with blockchain operations specified by the customers. The data store 215 may also include or be in communication with a credential vault that stores user identifiers and passwords and the computing server 130 may perform authentication of a customer. The data store 215 may also store data and metadata related to various operations involving an autonomous program protocol 152. For example, the computing server 130 may have the functionalities of serving as blockchain nodes of various blockchains 150. Various information related to a blockchain 150, such as the full ledgers of the blockchain 150, may also be stored in data store 215 to allow an inquirer to query for information on the blockchain 150, such as through the API 255.

In some embodiments, a sandbox engine 220 may provide a sandbox environment that allows a party that attempts to invoke one or more function calls of an autonomous program protocol 152 to simulate the operation at the computing server 130 first before actually invoking the autonomous program protocol 152 recorded on a blockchain 150. The sandbox environment may be a secure and isolated execution environment such as an isolated virtual machine that can be run without direct access to the underlying system resources so that any code run in the sandbox environment cannot access or modify any resources outside of the sandbox's allocated space or impact the main blockchain network. For example, a party may have an operation request that is to be sent to an autonomous program protocol 152 for execution. The party may use the sandbox engine 220 to simulate the result of the autonomous program protocol 152 carrying out the request and determine whether the result generates the desired outcome and/or whether the result generates any undesirable side effects. In some embodiments, the sandbox engine 220 allows an organization 120 to evaluate the operations and administration of a blockchain wallet to be maintained by the on-premises node 122. One or more policies specified by the organization 120 may also be tested in the sandbox engine 220.

In some embodiments, the blockchain node engine 225 provides the functionalities for one or more computing devices of the computing server 130 to serve as blockchain nodes of various blockchains 150. A blockchain node may be a node that participates in the validation and processing of operations on the blockchain 150. Depending on the sub-type of a blockchain node, some blockchain nodes may store a copy of the entire blockchain ledger, while other nodes may only store a partial copy of the ledger. The cryptographic key management engine 225 may maintain up-to-date functionalities to meet the current protocol requirements of various blockchains 150 so that the devices of the computing server 130 may continue to serve as blockchain nodes for blockchains 150. A customer of the computing server 130 may use a blockchain node maintained by the blockchain node engine 225 in various contexts. For example, a blockchain node may include the information of the ledger of a blockchain 150 and the customer may query the blockchain node engine 225 to retrieve information related to the blockchain 150 through an API call. In some embodiments, an on-premises node 122 may not have the full functionalities of a blockchain node or may not be fully updated to be compliant with the protocol requirements of a blockchain 150. An organization 120 may conduct blockchain operations by using an on-premises node 122 to reach the blockchain node engine 225. The blockchain node engine 225 may also provide the computing server 130 with access and information to various blockchains 150.

In some embodiments, a client node management engine 230 may manage the hosted nodes 135 of the customers of the computing server 130 and may set the initial settings of the on-premises nodes 122 before an on-premises node 122 is deployed to an organization 120. The computing server 130 may provide a node management platform for an organization 120 to adjust the settings of a node. Based on the settings, the client node management engine 230 may adjust the parameters and functionalities of the nodes associated with the organization 120. In some embodiments, a hosted node 135 and an on-premises node 122 may have different functionalities and updates of those two different types of nodes may be different. For example, a hosted node 135 may be run at the computing server 130 and may be updated instantly and dynamically based on the settings of the organization 120. An on-premises node 122 may be run at a device of the organization 120 and the organization 120 may adjust the on-premises node 122 directly or receive update installation packages that will change the on-premises node 122.

In some embodiments, the blockchain operation engine 235 may carry out and participate in carrying out various blockchain operations that are requested by customers, such as blockchain transactions, staking requests, and usages of autonomous program protocols 152. The blockchain operation engine 235 may generate the payload of the operation that is to be broadcasted to a blockchain 150. The payload may be referred to as an operation payload or a broadcast payload. Depending on embodiments with respect to where the private cryptographic key is saved, if the computing server 130 is in the custody of the private cryptographic key on behalf of a customer, the blockchain operation engine 235 may sign the payload and broadcast the operation through one of the blockchain nodes. In some embodiments, an organization customer has custody of the private cryptographic key. In such a case, the blockchain operation engine 235 may transmit the unsigned payload to an on-premises node 122 for the on-premises node 122 to verify and sign the payload. For example, the blockchain operation engine 235 may be used to generate a payload that is sent to an on-premises node 122 for verification of the operation intents before one or more relevant parties sign the payload using private cryptographic keys. The blockchain operation engine 235 may retrieve dynamic data elements that may be required to broadcast an operation to a blockchain 150. The dynamic data elements may be retrieved from a blockchain node. Based on the dynamic data elements that are dependent on the current conditions of the blockchain 150 and the non-dynamic data elements that are provided as part of the operation intent transmitted by the on-premises node 122, the blockchain operation engine 235 may generate an unsigned payload and transmit the payload to the on-premises node 122 for verification. Depending on the protocol of a blockchain 150, the payload may be in the format of bytecode.

In some embodiments, a multi-party computation (MPC) engine 240 provides or participates in MPC operations. The multi-party computation engine 240 may serve as a node in an MPC network where a group of nodes jointly perform computation without revealing the inputs of the nodes to each other. MPC may be used to securely generate a private cryptographic key. By using MPC, the private cryptographic key can be generated without any node possessing the entire key, thereby improving security and preventing any single point of failure. In some embodiments, any one of the multi-party computation engine 240, on-premises node 122, or hosted node 135 may participate in an MPC operation. In some embodiments, the computation of a private cryptographic key may completely occur within an organization 120 so that the multi-party computation engine 240 operated by the computing server 130 is not involved. In some embodiments, the multi-party computation engine 240 operated by the computing server 130 may store part of the shard of a private cryptographic key and the MPC is conducted using a few on-premises nodes 122 and the multi-party computation engine 240. U.S. Pat. No. 10,803,194, patented on Oct. 13, 2023, entitled “System and a Method for Management of Confidential Data,” is incorporated by reference herein for all purposes.

In some embodiments, a management platform backend 245 may maintain the backend component of one or more management platforms (e.g., SaaS platforms) that allow organizations 120 to create policies, manage client nodes, and perform other actions related to the services provided by the computing server 130. For example, the computing server 130 may provide a SaaS platform with a user-friendly front-end graphical user interface (GUI) that is rendered in a web browser. The front-end GUI is in communication with the management platform backend 245 that stores various inputs and settings provided by an organization 120. The SaaS platform may also allow organizations 120 to manage client nodes and perform other actions associated with the computing server 130. In some embodiments, the management platform backend 245 may additionally be associated with one or more APIs. An organization 120 may directly adjust policies and node settings through one or more API calls instead of going through a GUI.

In some embodiments, a digital distribution platform 250 may take the form of a software marketplace that allows an organization 120 to add one or more software applications to a client node (e.g., an on-premises node 122 or a hosted node 135) to expand the functionalities of the client node. For example, a user of the organization 120 may browse and select various applications of the digital distribution platform 250. For the applications that are selected by the organization 120, the code of the selected applications is incorporated into a client node to expand the functionalities and features of the client node. For example, an on-premises node 122 may initially include certain basic functionalities, such as one or more components that will be described in further detail in FIG. 3. An organization 120 may expand the functionalities of the on-premises node 122 by adding one or more software applications. In one case, an initial on-premises node 122 may not initially come with a sandbox environment such as a WASM module. The organization 120 may add such functionality through selecting the software application listed in the digital distribution platform 250. Each software application may be modularized so that the update of an individual software application typically does not affect the rest of the on-premises node 122. The use of modularized software applications may allow an organization 120 to fully control the operation of the on-premises node 122 and expand and update the functionalities by adding or updating a software application downloaded from the digital distribution platform 250. In some embodiments, the digital distribution platform 250 may be open or semi-open to various third-party developers to list their software applications that can be incorporated into a client node. For example, the computing server 130 may operate a blockchain node management ecosystem that allows other participants to design and list their software applications in the digital distribution platform 250.

In some embodiments, an application programming interface 255 allows a party to communicate with and access the functionalities of the computing server 130 directly through a programming language. For example, the computing server 130 may operate blockchain nodes and store ledgers of blockchains 150. A user may query the information of a blockchain 150 through an API call. In some embodiments, a user may also conduct a blockchain operation through a blockchain node operated by the computing server 130. The user may use an API call to initiate the operation request. In some embodiments, a user may also subscribe to the API 255. For example, the notifications can be provided in the form of pull notifications by conventional API in which the recipient may continuously poll the API. In some embodiments, the notifications can be provided through webhook, which may be a form of push API notifications where the computing server 130 automatically transmits the API notifications to the recipient when a matching event has occurred. An API notification, such as a webhook notification, may include a header and a payload. The payload may be in the format of key-value pairs that are in the format of JSON, XML, YAML, CSV, or another suitable format.

In some embodiments, a communication terminal 260 of the computing server 130 may provide network and blockchain connections between the computing server 130 and various entities that communicate with the computing server 130. The computing server 130 may serve as a node for various blockchains to provide up-to-date information about the state of the blockchain. The computing server 130 may include different terminals such as blockchain terminal, asset exchange terminal, and messaging application terminal. Each terminal may manage a data feed or a webpage that publishes information regarding the related services and server status. Each terminal may also include its individual API. A communication terminal 260 may also include an oracle machine that may serve as a data feed for an autonomous program protocol 152. The oracle machine may receive different data from various sources. For example, different parties may provide information and data to the oracle machine. When relevant information is obtained by the oracle machine, some code instructions of the autonomous program protocol 152 may be triggered if certain conditions are met.

In some embodiments, a staking engine 265 may allow a party to stake cryptocurrency in a blockchain 150 to participate in the consensus mechanism of a blockchain 150 that uses proof of stake. In staking, participants hold a certain amount of cryptocurrency as a stake in a blockchain 150. The participants use the amount as collateral to participate in block validation. By staking the cryptocurrency, participants usually receive rewards when new blocks are validated in the blockchain 150. In some embodiments, customers of the computing server 130 may delegate the cryptocurrency holdings to a pool of blockchain nodes that are responsible for validating transactions and creating new blocks on the blockchain 150. The staking engine 265 may provide a dashboard that includes information about staking performance and rewards. In some embodiments, staking of cryptocurrency of an organization 120 may require an authorization process such as a multi-party authorization that is discussed in this disclosure.

### Example Client Node

FIG. 3 is a block diagram representing an example on-premises node 122, in accordance with some embodiments. In the embodiment shown in FIG. 3, the on-premises node 122 may include a configuration and policy engine 310, data store 315, sandbox engine 320, blockchain node engine 325, digital asset security and management engine 330, key management engine 335, staking engine 340, multi-party computation engine 345, and API 350. The functions of the on-premises node 122 may be distributed among different components in a different manner than described below. Also, in various embodiments, the on-premises node 122 may include different, fewer, and/or additional components. For example, an on-premises node 122 may initially include fewer components and an organization 120 may expand the functionalities of the on-premises node 122 by adding software components to the on-premises node 122 from the digital distribution platform 250.

In some embodiments, a hosted node 135 may also have the functionalities and components described in FIG. 3. The functionalities and components of an on-premises node 122 and those of a hosted node 135 may be the same or different. The discussion of the on-premises node 122 may equally apply to a hosted node 135 and is not repeated in this disclosure for the hosted node 135, except for the differences already noted in the rest of the disclosure.

In some embodiments, a configuration and policy engine 310 may be a node-side policy management engine whose functionalities and usages are the same or very similar to those of the configuration and policy engine 210. An on-premises node 122 may provide a policy management platform for an organization 120 to establish policies associated with any blockchain operations. In some embodiments, a policy specified by an organization 120 may be stored on-premises and may be cryptographically enforced. For example, the configuration and policy engine 310 may possess a private cryptographic key, either through storing the private cryptographic key secretly in a conventional sense or through the ability to re-generate the private cryptographic key through MPC. An operation that is in compliance with one or more policies is signed by the configuration and policy engine 310 using the private cryptographic key to indicate policy compliance.

In some embodiments, a data store 315 may be a node-side data store whose functionalities and usages are the same or very similar to those of the data store 215. The data stored may include any suitable information related to the organization 120, node settings of the on-premises node 122, policies associated with the blockchain operations of the organization 120, and part of the shards of private cryptographic keys that may be used in MPC to generate one or more private cryptographic keys.

In some embodiments, a sandbox engine 320 may be a node-side sandbox engine whose functionalities and usages are the same or very similar to those of the sandbox engine 220. The sandbox engine 320 allows a user to perform testing and simulation using the on-premises node 122. In some embodiments, the sandbox engine 320 may be designed using code language that uses binary instructions such as WASM so that a secure and isolated execution environment may be established on the on-premises node 122 without affecting the security of the rest of the on-premises node 122. The sandbox engine 320 may be built using a blockchain-specific code (typically a higher-level language) and be cross-compiled into a binary instruction format such as WASM so that the sandbox engine 320 has the capability to operate using the blockchain-specific code while is not limited to only the blockchain specific code.

In some embodiments, the sandbox engine 320 may include an operation decoder 322. The operation decoder 322 has the capability of decoding blockchain codes to other types of codes, such as more human-readable parameters. In some embodiments, the operation decoder 322 may receive an operation payload of an operation. The operation payload is typically in bytecode. The operation decoder 322 may decode the payload to generate parameters of the operation by converting the bytecode back into human-readable parameters. The parameters, as reflected in the operation payload may be compared to the parameters in the original operation intent to see if the two sets of parameters match each other. The operation decoder 322 may be run on a binary language environment provided by the sandbox engine 320. The bytecode of the operation payload may be compiled from a source code that uses a higher-level language such as SOLIDITY, VYPER, or any programming language that is used by a specific blockchain 150. The sandbox engine 320 may simulate the programming language and decode the bytecode back to source code parameters.

In some embodiments, a blockchain node engine 325 may be a node-side blockchain node whose functionalities and usages are the same or very similar to those of the blockchain node engine 225. In some embodiments, an organization 120 may decide not to use an on-premises node 122 as a blockchain node, such as by isolating the on-premises node 122 from the general Internet due to security reasons. In such embodiments, the blockchain node engine 325 may not directly communicate with other nodes on a blockchain 150. Instead, any blockchain operations may be transmitted to the computing server 130 before the operations are broadcasted to a blockchain 150. In other embodiments, the blockchain node engine 325 may have the functionality of a blockchain node and serves as one of the blockchain nodes of a blockchain 150. An organization 120 may have full control over the extent of functionalities of the on-premises node 122.

In some embodiments, a digital asset security and management engine 330 may allow an organization 120 to establish an on-premises blockchain wallet system for the organization 120. The wallet system may reside within organization 120 to allow organization 120 to have full control of the wallet system. The digital asset security and management engine 330 may allow the organization to customize the wallet system and enforce one or more policies on the operations of the wallet system. The digital asset security and management engine 330 may operate with the key management engine 335 and the multi-party computation engine 345 to provide an MPC vault for storing private cryptographic keys in an MPC secure fashion. The API 350 of one or more on-premises nodes 122 allows individual users of the organization 120 to access the wallet system so that the digital asset security and management engine 330 may provide an institutional-grade Wallet as a Service (WaaS) to the users. An organization 120 may also choose to operate an on-premises node 122 as an “offline” node that is not accessible by the general Internet. In such a case, the wallet system established by the digital asset security and management engine 330 may provide a cold wallet to the organization 120.

In some embodiments, the digital asset security and management engine 330 may establish a wallet system by enforcing one or more policies of the organization 120 managed by the 310, verify a proposed blockchain operation involving the wallet system by verifying the intents, and using the key management engine 335 to sign the operation that is authorized. For example, an initiator user may initiate an operation request that includes a list of intent parameters, such as the blockchain network, the transaction amount, the source address, the destination address, etc. The digital asset security and management engine 330 may check whether the operation request is in compliance with one or more policies that are applicable to the operation request by comparing the intent parameters to the conditions and parameters of the policies. Upon verifying that the operation request is in compliance, the digital asset security and management engine 330 may transmit the operation request that includes the list of intent parameters to the computing server 130 to generate an un-signed operation payload of the operation. Since the on-premises node 122 may be treated by the organization 120 as a tightly managed secure environment, the computing server 130 may be treated as an untrusted source because the communications with the computing server 130 are through the Internet and may be tampered with. The un-signed operation payload may be transmitted to the digital asset security and management engine 330. In turn, the digital asset security and management engine 330 uses the operation decoder 322 of the sandbox engine 320 to decode the payload to extract the intent parameters as reflected in the payload. The digital asset security and management engine 330 may compare those extracted intent parameters to the original intent parameters in the operation request. If the intent parameters match, the digital asset security and management engine 330 may determine whether there is a policy governing the authorization of the operation. For example, in some embodiments, an operation may require multiple parties' authorization, such as from the initiator and one or more additional approvers. The digital asset security and management engine 330 uses the key management engine 335 to seek authorization and signatures from the approvers. In some cases, the configuration and policy engine 310 may also provide a signature to indicate that the operation is in compliance with the policies of the organization 120. After one or more signatures are obtained, the digital asset security and management engine 330 may send the signed operation payload to the computing server 130, which may serve as a blockchain node to broadcast the operation to a blockchain 150.

In some embodiments, a key management engine 335 may store and manage one or more cryptographic private cryptographic keys for various users of an organization 120 to allow users of the organization 120 to participate in various blockchains and to generate digital signatures for various blockchain operations such as requests to access autonomous program protocols 152. The cryptographic key management engine 335 stores various private cryptographic keys of the organization 120. In some embodiments, the key management engine 335 may store a private cryptographic key by storing the entire string of the private cryptographic key secretly in a conventional sense. In some embodiments, a key management engine 335 may store a shard of a fragment of a private cryptographic key for MPC to generate a private cryptographic key. For example, the organization 120 may operate multiple on-premises nodes 122 and the key management engine 335 of each node may store a shard of a respective fragment of the private cryptographic key. In some embodiments, upon retrieving a private cryptographic key, the key management engine 335 may generate a digital signature on behalf of a key owner. In some embodiments, the key management engine 335 may also have the capability of generating a new pair of private and public cryptographic keys. For example, the organization 120 may have a new user and the key management engine 335 may generate a new key pair. The private cryptographic key is kept secret while the public cryptographic key may be published to a blockchain 150 or a certificate authority.

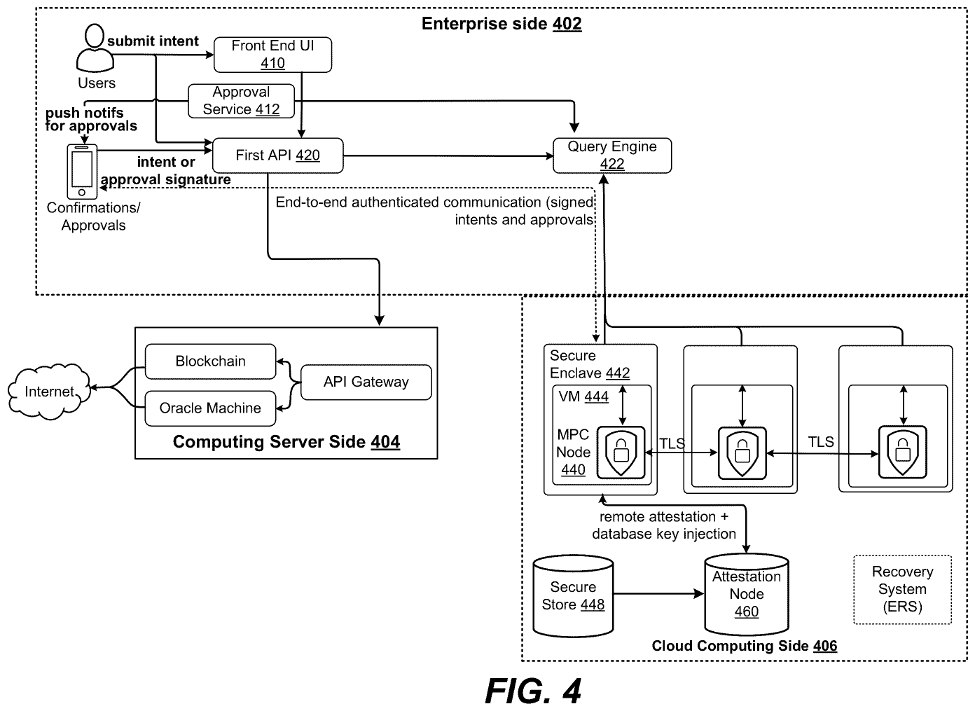

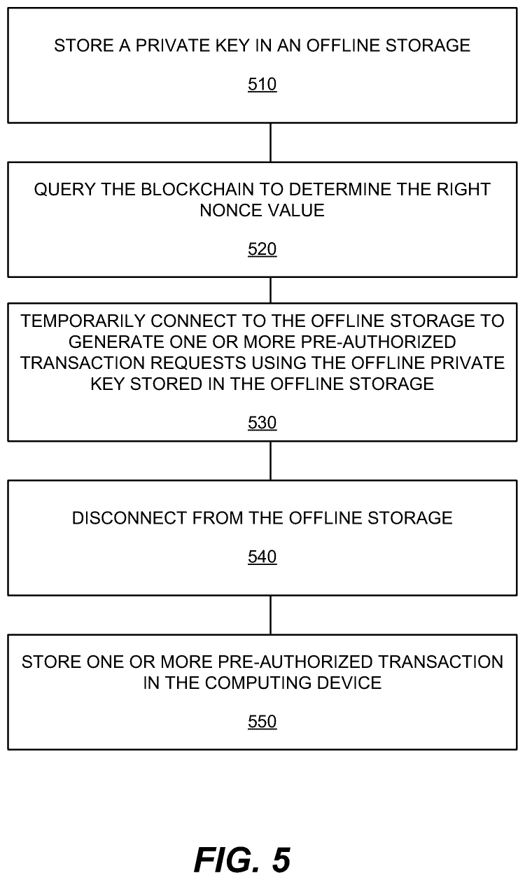

In some embodiments, an MPC engine 345 may provide the functionalities for MPC operations. Details of how one or more nodes may become part of an MPC system is further discussed in FIGS. 4 and 5. In some embodiments, a private cryptographic key of an organization 120 may be entirely controlled by the organization 120. For example, the organization 120 may operate multiple on-premises nodes 122. In some embodiments, the MPC operation may include one or more on-premises nodes 122 and a node from outside of the organization 120, such as the computing server 130 or a hosted node 135. The flexibility allows the organization 120 to decide how to most securely store its private cryptographic keys based on the situations of the organization 120.

In some embodiments, an API 350 may have functionalities and usages that are the same or very similar to those of the API 255. The API 350 may be used to serve users of the organization 120. For example, the API 350 may be used for user devices 110 to communicate with the wallet system maintained by the digital asset security and management engine 330.

### Example MPC Node System

FIG. 4 is a conceptual block diagram illustrating a multi-party computation (MPC) architecture 400, in accordance with some embodiments. The architecture may be used to implement one or more on-premises nodes 122 with the security and features of multi-party computation. Various engines discussed in FIG. 3 of an on-premises node 122 may be distributed or jointly executed by various components in this on-premises multi-party computation architecture 400. In some embodiments, an MPC system may also include one or more on-premises nodes 122 and one or more hosted nodes 135.

In some embodiments, the on-premises multi-party computation architecture 400 may be further divided into an enterprise side 402, a computing server side 404, and a Cloud computing side 406, although one or more components illustrated in FIG. 4 as being located on one side may be changed to another side in other embodiments. The functionalities and features discussed on each side may also be moved to another side in other embodiments. The enterprise side 402 may include components that are operated by an

enterprise, such as an organization 120, which is a customer of the computing server 130. For example, the enterprise uses the on-premises MPC offered by the computing server 130 and sets up the on-premises MPC architecture 400 based on various configurations and files provided by the computing server 130. The enterprise side 402 may include front-end user interfaces 410, such as mobile applications for the enterprise employees, to access enterprise services that are powered by the on-premises multi-party computation architecture 400. In the use case of blockchain operations, an example of the front-end user interface 410 may be a blockchain wallet user interface that allows an employee to manage blockchain units. Other examples of front-end user interfaces 410 may include various mobile applications published by the enterprise for various internal or external organization purposes. The enterprise side 402 may include one or more user devices 110, which may also be referred to as client devices. A client device may include one or more processors and memory. The memory storing executable instructions that, when executed by one or more processors, cause one or more processors to generate a user interface that is configured to receive a user input related to an MPC operation. For example, the MPC operation may be a signing of a blockchain operation using a private cryptographic key whose shards are distributed among multiple MPC nodes.

The enterprise side 402 may also include an approval service 412 that approve, deny, and adjust operations based on organizational policies, such as a multi-party authorization workflow. The approval service 412 may be part of the configuration and policy engine 310 and may be configured to carry out approval based on policies managed by the configuration and policy engine 310.

The enterprise side 402 may include one or more instances of an application programming interface, such as various instances of API 350, to communicate with other sides in the on-premises multi-party computation architecture 400. By way of example, the enterprise side 402 may include a first API 420 that is used to communicate with the computing server side 404 to access the features and services provided by the computing server 130, as discussed in FIG. 2. The enterprise side 402 may include a second API that takes the form of a query engine 422 for communication with the cloud computing side 406, which primarily performs MPC operations. The query engine 422 may use one or more network protocols to facilitate secure communication with the cloud computing side 406. By way of example, the query engine 422 may use message queuing telemetry transport (MQTT) protocol.

The computing server side 404 may include one or more features and functionalities offered by the computing server 130 as discussed in various engines and components of the computing server 130 in FIG. 2. For example, the computing server side 404 may include a blockchain node that is used to broadcast a blockchain operation initiated on the enterprise side 402 (e.g., initiated by a user using the front-end user interfaces 410) and verified and signed by MPC nodes that are executed in the cloud computing side 406. In some embodiments, to further protect the security of the enterprise, an MPC operation and a blockchain operation may be communicated to the Internet only through the computing server side 404. For example, in some embodiments, for certain sensitive operations, the enterprise side 402 only communicates to the computing server 130 and the MPC nodes through the first API 420 and query engine 422. In some embodiments, the external communications are routed through the computing server side 404.

In some embodiments, the cloud computing side 406 includes the architecture for executing multiple MPC nodes 440. The MPC nodes 440 may share some common operation parameters so that the MPC nodes 440 can cooperatively perform various types of MPC operations. Each MPC node 440 may also include individual node-specific parameters so that each MPC node 440 operates independently from another MPC node 440 to avoid the MPC nodes 440 sharing a single point of vulnerability.

In some embodiments, an MPC node 440 may be executed in a secure enclave 442. A secure enclave 442 may take the form of a hardware-based security technology that provides a trusted execution environment for protecting sensitive data and executing secure operations. The secure enclave 442 may be designed to be isolated and separate from the main operating system and other applications, creating a secure container, such as in the form of a secure virtual machine. The secure enclave 442 may be executed by memory and one or more processors of cloud infrastructure. Common cloud infrastructure providers, such as AMAZON AWS, provide a secure enclave service, such as AWS NITRO. In a secure enclave, the operation performed is not accessible or visible to the cloud infrastructure provider so that the MPC nodes 440 that are executed in the secure enclave 442 are not subject to attack from the cloud service provider or share the same point of vulnerability as the cloud service provider.

In some embodiments, a secure enclave 442 may require an injection of executable instructions to establish an operating system image for executing a virtual machine 444 that is executed by the secure hardware (memory and processors) that is provided by the cloud infrastructure provider. The secure enclave 442 executes the virtual machine 444 based on the operating system image that is injected into the secure enclave 442 and erases the content in the secure enclave 442 after the virtual machine 444 is shut down or ceases to operate. As such, from the perspective of operating an MPC node 440, the memory of the secure enclave 442 is associated with non-persistent storage that erases any content in the memory the MPC node 440 is terminated. An MPC node 440 is executed in the secure enclave 442 and includes executable instructions injected in the secure enclave 442 to create an execution environment, such as the virtual machine 444, although another type of virtualization or execution environment is also possible.

In some embodiments, the establishment of the execution environment of an MPC node 440 may be carried through a bootstrapping process where a bootstrapping package is injected into the secure enclave 442 and one or more configuration parameters in the form of different parts of a configuration file are fetched from various sources to establish the operating system image of the MPC node 440. In some embodiments, each MPC node 440 is executed in a separate instance of a secure enclave 442. Each MPC node 440 is established in the respective instance of the secure enclave 442 based on a configuration file that includes common parameters and node-specific parameters. In some embodiments, the configuration file of a particular MPC node 440 may be combined from multiple parts. Some parts are sensitive and encrypted, while other parts are shared parameters that allow the MPC nodes 440 cooperatively execute an MPC operation. For example, the various parts of the configuration file may include an encryptor key file that is uniquely associated with a particular MPC node 440, a node-specific configuration part, and a common configuration part. The encryptor key file and the node-specific configuration part may be saved in the respective instance of the secure store 448 of the cloud computing side 406. Further detail on the division of the configuration file and the deployment of MPC nodes is discussed in U.S. patent application Ser. No. 18/232,797, entitled “Multi-Party Computation Node Configuration,” filed on Aug. 10, 2023, which is incorporated by reference herein for all purposes.

An MPC node 440 may perform a key ceremony process that includes an attestation process to ensure the execution environment of the secure enclave 442 is secured and untampered before an MPC operation is carried out. Since the operating image and configuration file of an MPC node 440 is injected into the secure enclave 442 from an external source, even though the secure enclave 442 may be a secure environment, the executable instructions may have been tampered with before injected into the secure enclave 442, thereby creating a vulnerability to the MPC architecture. In some embodiment, each MPC node 440 may perform a key ceremony process with an attestation node 460 before a private cryptographic key shard is decrypted and made available in the secure enclave 442 to perform any MPC operation. Each secure enclave 442 may be associated with its own attestation node 460.

An MPC operation may be a cryptographic operation that allows multiple MPC node 440 to jointly compute an operation over the node's respective unshared information without revealing the information to another node. Although an MPC operation may be any computations that follow the MPC protocol, typically, an MPC operation is associated with a cryptographic operation that ensures the security of an operation. For example, the MPC nodes 440 may carry out an MPC operation to cryptographically sign an operation by generating a digital signature using a private cryptographic key that is broken into multiple key shards. In some embodiments, each MPC node 440 may be in possession of a key shard but not the entire private cryptographic key, which is not combined or possessed by a single node or party. As such, a private cryptographic key may be secured and stored as key shards. Another example of MPC operation may be the use of a private cryptographic key that is computed from multiple key shards to decrypt encrypted data. For example, an external source may encrypt data using the public cryptographic key corresponding to the private cryptographic key whose key shards are stored. The encrypted data may be routed to the MPC nodes to perform an MPC operation to decrypt and authenticate the data. The on-premises multi-party computation architecture 400 allows an enterprise to manage an MPC architecture using a deployment method and architecture developed by the computing server 130. The on-premises multi-party computation architecture 400 allows the enterprise to perform various secure operations using MPC computations. A blockchain operation is going to be used as an example in FIG. 4 to illustrate a process using the on-premises MPC architecture 400, but other processes outside of the blockchain area that include the use of MPC technology are also possible to do in a similar fashion using the on-premises MPC architecture 400, such as in secure voting, other financial and economic applications, privacy-preserving data analysis, fraud detection, cybersecurity, and secure computing outsourcing.

By way of example, an enterprise end user, such as an employee, may initiate a blockchain operation request, such as sending a quantity of a blockchain unit to another blockchain address from the enterprise's blockchain address. The enterprise's blockchain address may correlate to a public cryptographic key of the enterprise whose corresponding private cryptographic key is stored as key shards in the MPC nodes 440. The end user may initiate the blockchain operation request through the front-end user interface 410.

Upon receiving the blockchain operation request, the approval service 412 may examine relevant authorization policies that are applicable to the blockchain operation request to determine whether the requestor is authorized to perform the blockchain operation. The authorization policy may specify that the operation requires multiple parties' authorizations, such as from a manager of the requestor and/or a financial administrator of the enterprise. The first API 420 may work with the computing server 130 to complete the multi-party authorization process. For example, authorization and approval requests may be sent to various user devices 110 of the approvers. Detail of various examples of authorization processes is further discussed in U.S. patent application Ser. No. 18/196,103, entitled “Blockchain Operation Authorization and Verification,” which is incorporated by reference herein for all purposes.

Assuming the authorization process is completed or approved, the enterprise side 402 may send a query to the MPC nodes 440 through the query engine 422 to ask for a cryptographic signature generated by the private cryptographic key of the enterprise. The MPC nodes 440 may perform an MPC operation using key shards respectively possessed by the MPC nodes 440 to generate, in a signature creation process, a cryptographic signature for a broadcast payload of a blockchain operation. The signed payload may be transmitted through the first API 420 to the computing server 130. The computing server 130 broadcasts the signed broadcast payload to the targeted blockchain on behalf of the enterprise.

In some embodiments, there can be a connected MPC system and an independent offline MPC system. The connected MPC system may be used to store key shards of a hot wallet that can broadcast blockchain transaction instantaneously or almost instantaneously. The offline MPC system may be independent and not connected to the connected MPC system or the rest of the network of the organization 120. The offline MPC system may be used to store key shards of a cold wallet that stores a private cryptographic key in an offline manner. The cold wallet provides extra security to the blockchain address corresponding to the private cryptographic key.

### Example Transaction Pre-Authorization Process

FIG. 5 is a flowchart depicting an example process for pre-authorizing transactions associated with a private cryptographic key stored in an offline storage, in accordance with some embodiments. A private cryptographic key stored in an offline storage provides extra security to safeguard the private cryptographic key because it is extremely difficult or nearly impossible for a malicious party to hack into an offline system. However, storing a private cryptographic key in an offline storage would result in various transaction hurdles that prevent transactions from being carried out efficiently. For example, a person may need to travel physically to the offline storage location to use the private cryptographic key to sign a blockchain transaction. This reduces the efficiency of operation. For example, if the blockchain address receives a quantity of blockchain unit, the owner of the blockchain address cannot immediately stake the blockchain unit because there is a significant operation hurdle that needs to be overcome before a private cryptographic key stored in the offline system can be used. In this disclosure, the private cryptographic key stored in the offline system may be referred to as a cold private cryptographic key or an offline private cryptographic key.

In some embodiments, a computing device can generate one or more pre-authorized transaction requests that are pre-signed by the offline private cryptographic key and the pre-authorized transaction requests may be stored in the computing device that is connected. Certain types of blockchain transactions do not pose as much security risk compared to other transactions and also those types of blockchain transactions may include parameters that can be pre-determined. Staking requests and unstaking requests are examples of transaction requests that may be pre-authorized.

Blockchain staking and unstaking typically do not pose a significant security risk to the owner of the blockchain unit even if the pre-authorized transaction requests are improperly obtained by a malicious party. Staking typically sends a predefined quantity of a blockchain unit to a validator address that belongs to the owner. In unstaking, the return address is usually predefined in the original staking or is predetermined based on the validatory address. Hence, even if the pre-authorized transaction requests are obtained by a malicious party, a malicious party may only be able to send a certain quantity of a blockchain unit to a validator address that is associated with the blockchain owner. Likewise, for unstaking, the blockchain unit will only go back to an address belonging to the blockchain owner.

Blockchain staking and unstaking are also associated with certain predetermined parameters and may not involve dynamic parameters that require determination at the time of the transaction. In a blockchain transaction request, the parameters that need to be specified typically include the “from” address, the “to” address, the quantity of the blockchain unit, a nonce that serves as an address-specific counter, a signature generated by the private cryptographic key, and parameters that are related to the priority or maximum transaction fees (e.g., gas fees). Unlike a typical transfer transaction where the “to” address will vary based on the recipient, in a staking process, the “to” address is fixed as the validator address. The quantity usually is also predetermined. For example, in the Ethereum blockchain, the quantity for staking is in the increment of 32 ETH. The signature may be pre-signed by the offline private cryptographic key. The nonce is the only variable that is transaction-specific, but this can be determined ahead of time by queuing the state of the blockchain to find out the nonce associated with the “from” blockchain address. Typically, the “from” blockchain address is the address that corresponds to the public cryptographic key generated by the offline private cryptographic key.

In some embodiments, other types of transaction requests may also be pre- authorized without posing a significant security risk to the owner of the private cryptographic key. For example, the owner may be in a recurring transaction with a known third party. Since the blockchain address of the third party is known, a series of one or more pre-authorized transaction requests may be generated. In some embodiments, pre-authorized transaction requests may also be generated for transactions to third party custodians such as a broker or a liquidity provider.

One or more steps in the process 500 may be performed by a computing device. The computing device may be a connected node 124, offline node 126, a hosted node 135, or a user device 110, depending on the implementation and embodiment. In some embodiments, even though the computing device is described as a device in the singular form, it includes an MPC system or one or more nodes in the system environment 100. For example, the performing computing device may be an MPC system that involves multiple nodes distributively or cooperatively to perform process 500.

The process 500 may include storing 510 a private cryptographic key in an offline storage. The private cryptographic key is used to generate a public cryptographic key that corresponds to a blockchain address of a blockchain 150. The private cryptographic key may be referred to as an offline private cryptographic key. The key may be stored as a whole or stored as multiple shards in a distributed manner.

The computing device may query 520 the blockchain 150 (e.g., query the ledger associated with the blockchain address) to inquire about the current nonce of the blockchain address. The blockchain address is the address that corresponds to the public cryptographic key generated by the offline private cryptographic key. The nonce may be a counter that starts with an initial state (e.g., 0 in the Ethereum blockchain) and is incremented based on the number of transactions initiated from the blockchain address. The incrementation may be a fixed step increment but may not have to be 1. In some blockchains 150, in order for a transaction request to be valid, the nonce is required to be the right nonce value. For example, the nonce in the next transaction request initiated by the blockchain address may need to be the next increment of the existing nonce of the last transaction posted on the blockchain 150. The computing device may query 520 the blockchain 150 to determine the right nonce value. The computing device may also generate a series of next nonces to generate a series of pre-approved transaction requests.

In some embodiments, a computing device that carries the next nonce or next multiple nonces may temporarily connect 530 to the offline storage to generate one or more pre-authorized transaction requests using the offline private cryptographic key stored in the offline storage. The computing device that temporarily connects to the offline storage may be a portable device (e.g., a mobile electronic device, or a USB drive). For example, a person may carry a USB drive that includes the values of the nonces and connect the USB drive to the offline storage.

The generation of the one or more pre-authorized transaction requests may be generated by the computing device that is temporarily connected to the offline storage or may be generated by an offline device that is associated with the offline storage. For example, the offline storage may be a computer that stores the private cryptographic key and is capable of generating the pre-authorized transaction requests using the nonce. In another example, the offline storage includes an offline MPC system. After the computing device is connected to the offline storage, the offline MPC system may calculate the offline private cryptographic key based on various key shards that are distributed in various offline MPC nodes.

The generation of a pre-authorized transaction request may include specifying the parameters in the transaction request. The parameters may include the nonce, a quantity of a blockchain unit, and a recipient address. In a staking or unstaking request, the quantity of a blockchain is typically predetermined. The recipient address for a staking request is typically the validator address that is known. In unstaking requests, the return address typically corresponds to the blockchain address corresponding to the public cryptographic key or, in some cases, the return address is fixed by the validator so that such a parameter does not need to be specified. The offline private cryptographic key may be used to cryptographically encrypt the transaction request (e.g., a portion of the transaction request that includes the nonce) with the right parameters to generate a signature for the transaction request.

In some embodiments, a series of pre-authorized transactions may be generated using a series of nonce. Even if one or more nonces in the series are subsequently used for other transaction requests that are not part of the pre-authorization, the rest of the transaction requests may still be valid as long as the nonces are incremental and there are no transaction requests that use the same nonce.

In some embodiments, multiple versions of alternative transaction requests may be generated for each nonce in the series. This is to give flexibility to the owner in selecting which transaction request the owner may want to use at a given time that corresponds to a given nonce. For example, for staking and unstaking, each nonce may be used to generate two alternative transaction requests, one for staking and another for unstaking. Hence, at a particular given state of the blockchain address that a particular nonce is the next to use, the owner can choose to perform a pre-authorized staking transaction request or a pre-authorized unstaking transaction request. After the particular nonce is used, the next nonce may also be associated with two alternative transaction requests for the owner to choose from. In some embodiments, each nonce may also be associated with multiple transaction requests, such as transaction requests with different quantities of blockchain units.

In some embodiments, to limit potential vulnerability, each batch of generation of pre-authorized requests may be limited to a certain number of nonces so that a malicious party cannot perform more than a maximum number of transactions even if the malicious party improperly obtains all pre-authorized requests.

In some embodiments, after the pre-authorized transaction requests are generated, the computing device that is temporarily connected to the offline storage may be disconnected 540 from the offline storage so that the offline private cryptographic key is not further accessible.

The one or more pre-authorized transaction requests may be stored 550 in the computing device and/or transferred to another computing device such as a connected node 124, a user device 110, or a hosted node 135. The one or more re-authorized transaction requests are broadcastable to the blockchain 150 without further retrieving the offline private cryptographic key stored in the disconnected storage because the re-authorized transaction requests include the parameters needed in a transaction request and the signature signed by the offline private cryptographic key.

In some embodiments, each pre-authorized transaction request may be stored in an encrypted form. Various ways to encrypt a pre-authorized transaction request are possible. For example, the pre-authorized transaction request may be encrypted by another private cryptographic key that also belongs to the owner. For example, the owner may include a hot wallet and a cold wallet. The cold wallet private cryptographic key is the offline private cryptographic key that is stored in the offline storage. The hot wallet private cryptographic key is another private cryptographic key that allows the owner to perform one or more blockchain transactions in a more instantaneous manner. The hot wallet private cryptographic key may be used to encrypt the pre-authorized transaction request. In some embodiment, an organization 120 may include an online MPC system. A pre-authorized transaction request may be broken into multiple shards and may be distributively stored among the MPC nodes of the online MPC shards. In other words, in some embodiments, the offline private cryptographic key may be stored in shards in an offline MPC system. After a pre-authorized transaction request is generated, the pre-authorized transaction request may be stored in shards in an online MPC system. Other suitable ways to encrypt the pre-authorized transaction request are also possible.

In some embodiments, the pre-authorized transaction request also allows an owner to perform staking in a more efficient manner. For example, a blockchain node may detect a quantity of blockchain units transmitted to the blockchain address of the owner. In turn, the blockchain node may immediately broadcast a pre-authorized transaction request with the right nonce to the blockchain 150 to stake the quantity of blockchain units. The broadcast of the pre-authorized transaction request may be directed to the execution layer of the blockchain 150. Upon the verification in the consensus layer, the pre-authorized transaction request becomes a posted transaction in the ledger associated with the blockchain address and the transaction is completed. The broadcast of the pre-authorized transaction request can be done without further retrieving the private cryptographic key.

### Example Blockchain Architecture

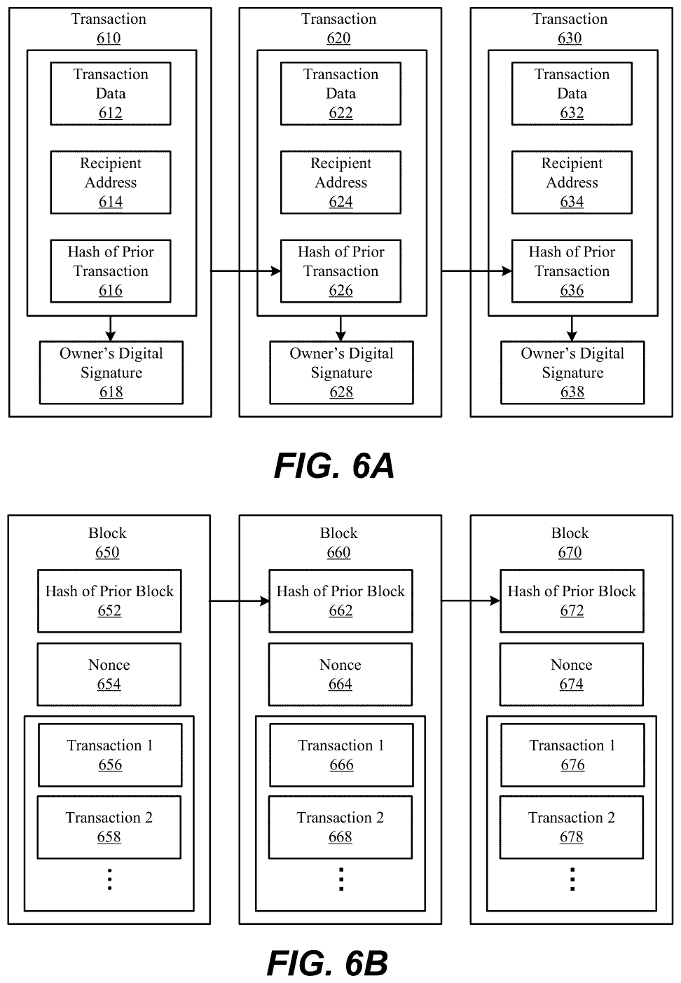

FIG. 6A is a block diagram illustrating a chain of transactions broadcasted and recorded on a blockchain, in accordance with some embodiments. The transactions described in FIG. 6A may correspond to any of the transactions and the transfer of blockchain-based units. A blockchain-based unit can be a cryptocurrency, a token, an NFT, a wrapped token, etc.

In some embodiments, a blockchain is a distributed system. A distributed blockchain network may include a plurality of blockchain nodes. Each blockchain node is a user or a server that participates in the blockchain network. In a public blockchain, any participant may become a blockchain node of the blockchain (permissionless). The blockchain nodes collectively may be used as a computing system that serves as a virtual machine of the blockchain. In some embodiments, the virtual machine or a distributed computing system may be simply referred to as a computer. Any blockchain node of a public blockchain may broadcast transactions for the nodes of the blockchain to record. Each digital wallet is associated with a private cryptographic key that is used to sign transactions and prove the ownership of a blockchain-based unit.

The ownership of a blockchain-based unit may be traced through a chain of transactions. A transaction may be referred to as a blockchain operation, which may include a transfer of a cryptocurrency or a token, creation of a token, recordation of an autonomous program protocol (e.g., a smart contract), execution of the autonomous program protocol, and another decentralized application operation. In FIG. 6A, a chain of transactions may include a first transaction 610, a second transaction 620, and a third transaction 630, etc. The transactions in FIG. 6A are typically recorded in the ledger of the blockchain. Each of the transactions in the chain may have a fairly similar structure except the very first transaction in the chain. The first transaction of the chain may be generated by a smart contract or a mining process and may be traced back to the smart contract that is recorded on the blockchain or the first block in which the blockchain-based unit was generated. While each transaction is illustrated as linking to a prior transaction in FIG. 6A, the transaction does not need to be recorded on consecutive blocks on the blockchain. For example, the block recording the transaction 610 and the block recording the transaction 620 may be separated by hundreds or even thousands of blocks. In some embodiments, the traceback of the prior block may be tracked by the hash of the prior block that is recorded by the current block. In other blockchains, there are no links among the transactions. The transactions are simply ordered temporally on a ledger that includes a number of blocks. For example, in some embodiments, an account model is used, and transactions do not have any references to previous transactions. In those blockchains, transactions are not chained and do not contain the hash of the previous transaction.

Referring to one of the transactions in FIG. 6A, for illustration, the transaction 620 may be referred to as a current transaction. Transaction 610 may be referred to as a prior transaction and transaction 630 may be referred to as a subsequent transaction. Each transaction includes a transaction data 622, a recipient address 624, a hash of the prior transaction 626, and the current transaction's owner's digital signature 628. The transaction data 622 records the substance of the current transaction 620. For example, the transaction data 622 may specify a transfer of a quantity of a blockchain-based unit (e.g., a coin, a blockchain token, etc.). In some embodiments, the transaction data 622 may include code instructions of a smart contract.

In some embodiments, the recipient address 624 is a version of the public cryptographic key that corresponds to the private cryptographic key of the digital wallet of the recipient. In one embodiment, the recipient address 624 is the public cryptographic key itself. In another embodiment, the recipient address 624 is an encoded version of the public cryptographic key through one or more functions such as some deterministic functions. For example, the generation of the recipient address 624 from the public cryptographic key may include hashing the public cryptographic key, adding a checksum, adding one or more prefixes or suffixes, encoding the resultant bits, truncating the address, and/or other suitable algorithmic operations. The recipient address 624 may be a unique identifier of the digital wallet of the recipient on the blockchain.

The hash of the prior transaction 626 may be the hash of the entire transaction data of the prior transaction 610. Likewise, the hash of the prior transaction 636 is the hash of the entire transaction data of the transaction 620. The hashing of the prior transaction 610 may be performed using a hashing algorithm such as a secure hash algorithm (SHA) or a message digest algorithm (MD). In some embodiments, the owner corresponding to the current transaction 620 may also use the public cryptographic key of the owner to generate the hash. The hash of prior transaction 626 provides a traceback of the prior transaction 610 and also maintains the data integrity of the prior transaction 610.

In generating a current transaction 620, the digital wallet of the current owner of the blockchain-based unit may use its private cryptographic key to encrypt the combination of the transaction data 622, the recipient address 624, and the hash of prior transaction 626 to generate the owner's digital signature 628. To generate the current transaction 620, the current owner may specify a recipient by including the recipient address 624 in the digital signature 628 of the current transaction 620. The subsequent owner of the blockchain-based unit is fixed by the recipient address 624. In other words, the subsequent owner that generates the digital signature 638 in the subsequent transaction 630 is fixed by the recipient address 624 specified by the current transaction 620. To verify the validity of the current transaction 620, any nodes in the blockchain network may trace back to the prior transaction 610 (by tracing the hash of prior transaction 626) and locate the recipient address 614. The recipient address 614 corresponds to the public cryptographic key of the digital signature 628. Hence, the nodes in the blockchain network may use the public cryptographic key to verify the digital signature 628. Hence, a current owner who has the blockchain-based unit tied to the owner's blockchain address can prove the ownership of the blockchain-based unit. In this disclosure, it can be described as the blockchain-based unit being connected to a public cryptographic key of a party because the blockchain address is derived from the public cryptographic key. For example, the computing server 130 may own blockchain-based units. The blockchain-based units are connected to one of the public cryptographic keys of the computing server 130.

The transfer of ownership of a blockchain-based unit may be initiated by the current owner of the blockchain-based unit. To transfer the ownership, the owner may broadcast the transaction that includes the digital signature of the owner and a hash of the prior transaction. A valid transaction with a verifiable digital signature and a correct hash of the prior transaction will be recorded in a new block of the blockchain through the block generation process.

FIG. 6B is a block diagram illustrating a connection of multiple blocks in a blockchain, in accordance with some embodiments. Each block of a blockchain, except the very first block which may be referred to as the genesis block, may have a similar structure. The blocks together may be referred to as the ledger of the blockchain. The blocks 650, 660, and 660 may each include a hash of the prior blockchain 652, a nonce 654, and a plurality of transactions (e.g., a first transaction 656, a second transaction 658, etc.). Note that the nonce 654 may be specific to a block in the blockchain 150 instead of a nonce that is specific to a blockchain address that is discussed in FIG. 5. Each transaction may have the structure shown in FIG. 6A. An autonomous program protocol may also be stored in one of the transactions and execution results of the autonomous program protocol may be stored in subsequent transactions.

In a block generation process, a new block may be generated through a consensus mechanism such as mining (e.g., proof of work) or voting (e.g., proof of stake). For the mining process of a blockchain, any nodes in the blockchain system may participate in the mining process. The generation of the hash of the prior block may be conducted through a trial-and-error process. The entire data of the prior block (or a version of the prior block such as a simplified version) may be hashed using the nonce as a part of the input. The blockchain may use a certain format in the hash of the prior block in order for the new block to be recognized by the nodes as valid. For example, in one embodiment, the hash of the prior block needs to start with a certain number of zeroes in the hash. Other criteria of the hash of the prior block may also be used, depending on the implementation of the blockchain.

In a voting process, the nodes in a blockchain system may vote to determine the content of a new block. Depending on the embodiment, a selected subset of nodes or all nodes in the blockchain system may participate in the votes. For example, in some embodiments, a staking process is required before a node can participate in the voting process. When there are multiple candidate new blocks that include different transactions are available, and the nodes will vote for one of the blocks to be linked to the existing block. The voting may be based on the voting power of the nodes.

By way of an example of a block generation process using mining, in generating the hash of prior block 662, a node may randomly combine a version of the prior block 650 with a random nonce to generate a hash. The generated hash is somewhat of a random number due to the random nonce. The node compares the generated hash with the criteria of the blockchain system to check if the criteria are met (e.g., whether the generated hash starts with a certain number of zeroes in the hash). If the generated hash fails to meet the criteria, the node tries another random nonce to generate another hash. The process is repeated for different nodes in the blockchain network until one of the nodes finds a hash that satisfies the criteria. The nonce that is used to generate the satisfactory hash is the nonce 664. The node that first generates the hash 662 may also select what transactions that are broadcasted to the blockchain network are to be included in the block 660. The node may check the validity of the transaction (e.g., whether the transaction can be traced back to a prior recorded transaction and whether the digital signature of the generator of the transaction is valid). The selection may also depend on the number of broadcasted transactions that are pending to be recorded and also the fees that may be specified in the transactions. For example, in some embodiments, each transaction may be associated with a fee (e.g., gas) for having the transaction recorded. After the transactions are selected and the data of the block 660 is fixed, the nodes in the blockchain network repeat the trial-and-error process to generate the hash of prior block 672 by trying different nonce. In embodiments that use voting to generate new blocks, a nonce may not be needed. A new block may be linked to the prior block by including the hash of the prior block.

New blocks may be continued to be generated through the block generation process. A transaction of a blockchain-based unit (e.g., an electronic coin, a blockchain token, etc.) is complete when the broadcasted transaction is recorded in a block. In some embodiments, the transaction is considered settled when the transaction is considered final. A transaction is typically considered final when there are multiple subsequent blocks generated and linked to the block that records the transaction.

In some embodiments, some of the transactions 656, 658, 666, 668, 676, 678, etc. may include one or more smart contracts. The code instructions of the smart contracts are recorded in the block and are often immutable. When conditions are met, the code instructions of the smart contract are triggered. The code instructions may cause a computer (e.g., a virtual machine of the blockchain) to carry out some actions such as generating a blockchain-based unit and broadcasting a transaction documenting the generation to the blockchain network for recordation.

### Computing Machine Architecture

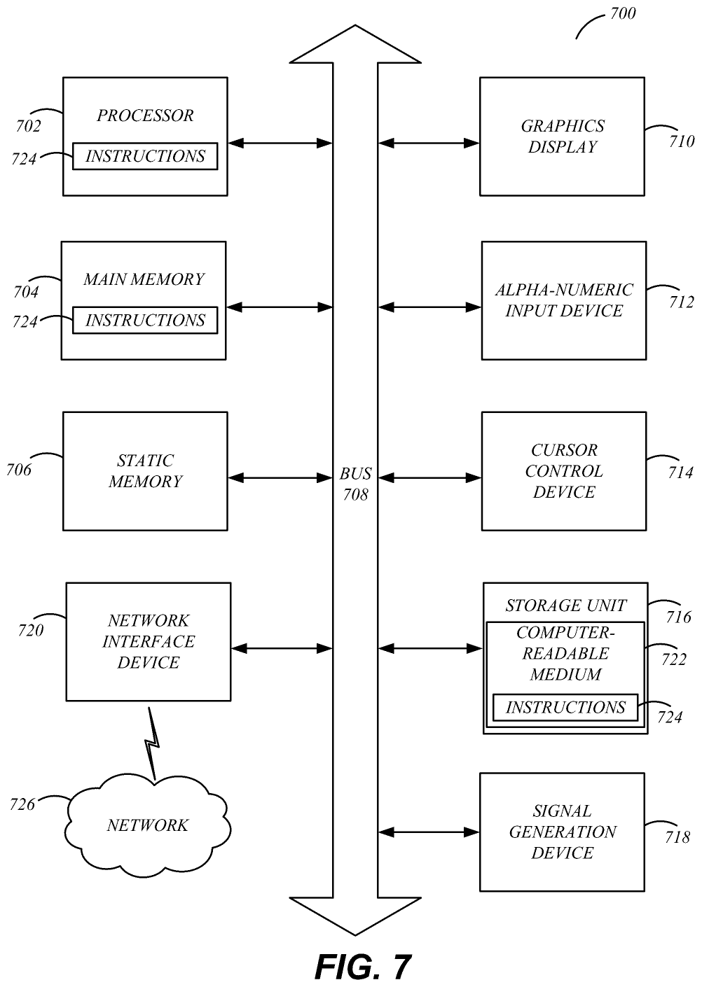

FIG. 7 is a block diagram illustrating components of an example computing machine that is capable of reading instructions from a computer-readable medium and executing them in a processor (or controller). A computer described herein may include a single computing machine shown in FIG. 7, a virtual machine, a distributed computing system that includes multiple nodes of computing machines shown in FIG. 7, or any other suitable arrangement of computing devices.

By way of example, FIG. 7 shows a diagrammatic representation of a computing machine in the example form of a computer system 700 within which instructions 724 (e.g., software, program code, or machine code), which may be stored in a computer-readable medium for causing the machine to perform any one or more of the processes discussed herein may be executed. In some embodiments, the computing machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The structure of a computing machine described in FIG. 7 may correspond to any software, hardware, or combined components shown in FIGS. 1, 2, and 3, including but not limited to, the user device 110, the computing server 130, an on-premises node 122, a hosted node 135, a node of a blockchain network, and various engines, modules interfaces, terminals, and machines shown in FIG. 2. While FIG. 7 shows various hardware and software elements, each of the components is described in FIGS. 1, 2, and 3 may include additional or fewer elements.

By way of example, a computing machine may be a personal computer (PC), a tablet PC, a set-top box (STB), a personal digital assistant (PDA), a cellular telephone, a smartphone, a web appliance, a network router, an internet of things (IOT) device, a switch or bridge, or any machine capable of executing instructions 724 that specify actions to be taken by that machine. Further, while only a single machine is illustrated, the term “machine” shall also be taken to include any collection of machines that individually or jointly execute instructions 724 to perform any one or more of the methodologies discussed herein.

The example computer system 700 includes one or more processors (generally, processor 702) (e.g., a central processing unit (CPU), a graphics processing unit (GPU), a digital signal processor (DSP), one or more application-specific integrated circuits (ASICs), one or more radio-frequency integrated circuits (RFICs), or any combination of these), a main memory 704, and a static memory 706, which are configured to communicate with each other via a bus 708. The computer system 700 may further include graphics display unit 710 (e.g., a plasma display panel (PDP), a liquid crystal display (LCD), a projector, or a cathode ray tube (CRT)). The computer system 700 may also include an alphanumeric input device 712 (e.g., a keyboard), a cursor control device 714 (e.g., a mouse, a trackball, a joystick, a motion sensor, or other pointing instrument), a storage unit 716, a signal generation device 718 (e.g., a speaker), and a network interface device 720, which also are configured to communicate viThe bus 708.

The storage unit 716 includes a computer-readable medium 722 on which are stored instructions 724 embodying any one or more of the methodologies or functions described herein. The Instructions 724 may also reside, completely or at least partially, within the main memory 704 or within the processor 702 (e.g., within a processor's cache memory) during execution thereof by the computer system 700, the main memory 704 and the processor 702 also constituting computer-readable media. The Instructions 724 may be transmitted or received over a network 726 viThe network interface device 720.

While computer-readable medium 722 is shown in an example embodiment to be a single medium, the term “computer-readable medium” should be taken to include a single medium or multiple media (e.g., a centralized or distributed database, or associated caches and servers) able to store instructions (e.g., instructions 724). The computer-readable medium may include any medium that is capable of storing instructions (e.g., instructions 724) for execution by the machine and that causes the machine to perform any one or more of the methodologies disclosed herein. The computer-readable medium may include, but not be limited to, data repositories in the form of solid-state memories, optical media, and magnetic media. The computer-readable medium does not include a transitory medium such as a signal or a carrier wave.

### Additional Configuration Considerations

Generally, any key described in this disclosure may refer to the whole key or a shard of the key. For example, in some embodiments, whenever a private cryptographic key is mentioned, the private cryptographic key may be stored as a whole or stored as two or more shards part of a distributed MPC cluster, each shard being securely used by a MPC node part of a MPC protocol to perform a cryptographic operation, for example but not limited to a signing operation.

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Any feature mentioned in one claim category, e.g., method, can be claimed in another claim category, e.g., computer program product, system, or storage medium, as well. The dependencies or references back in the attached claims are chosen for formal reasons only. However, any subject matter resulting from a deliberate reference back to any previous claims (in particular multiple dependencies) can be claimed as well, so that any combination of claims and the features thereof is disclosed and can be claimed regardless of the dependencies chosen in the attached claims. The subject matter may include not only the combinations of features as set out in the disclosed embodiments but also any other combination of features from different embodiments. Various features mentioned in the different embodiments can be combined with explicit mentioning of such combination or arrangement in an example embodiment or without any explicit mentioning. Furthermore, any of the embodiments and features described or depicted herein may be claimed in a separate claim and/or in any combination with any embodiment or feature described or depicted herein or with any of the features.

In some embodiments, a computer-readable medium includes one or more computer-readable media that, individually, distributively, or together, include instructions that, when executed by one or more processors, cause the one or more processors to perform, individually, distributively, or together, the steps of the instructions stored on the one or more computer-readable media. Similarly, a processor includes one or more processors or processing units that, individually, distributively, or together, perform the steps of instructions stored on a computer-readable medium. When in this disclosure refers to one or more processors performing one or more steps, in various embodiments the one or more processors may individually, distributively, or together perform those steps and the use of the phrase one or more processors by no means to imply that a single process has to perform every single step. For example, in a device that has multiple processors, one processor may perform step one and another processor may perform step two. Similar situation may apply to distributed computing. In various embodiments, the discussion of one or more processors that carry out a process with multiple steps does not require any one of the processors to carry out all of the steps. For example, a processor A can carry out step A, a processor B can carry out step B using, for example, the result from the processor A, and a processor C can carry out step C, etc. The processors may work cooperatively in this type of situation such as in multiple processors of a system in a chip, in Cloud computing, or in distributed computing.

Some portions of this description describe the embodiments in terms of algorithms and symbolic representations of operations on information. These operations and algorithmic descriptions, while described functionally, computationally, or logically, are understood to be implemented by computer programs or equivalent electrical circuits, microcode, or the like. Furthermore, it has also proven convenient at times, to refer to these arrangements of operations as engines, without loss of generality. The described operations and their associated engines may be embodied in software, firmware, hardware, or any combinations thereof.

Any of the steps, operations, or processes described herein may be performed or implemented with one or more hardware or software engines, alone or in combination with other devices. In some embodiments, a software engine is implemented with a computer program product comprising a computer-readable medium containing computer program code, which can be executed by a computer processor for performing any or all of the steps, operations, or processes described. The term “steps” does not mandate or imply a particular order. For example, while this disclosure may describe a process that includes multiple steps sequentially with arrows present in a flowchart, the steps in the process do not need to be performed in the specific order claimed or described in the disclosure. Some steps may be performed before others even though the other steps are claimed or described first in this disclosure. Likewise, any use of (i), (ii), (iii), etc., or (a), (b), (c), etc. in the specification or in the claims, unless specified, is used to better enumerate items or steps and also does not mandate a particular order.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. In addition, the term “each” used in the specification and claims does not imply that every or all elements in a group need to fit the description associated with the term “each.” For example, “each member is associated with element A” does not imply that all members are associated with an element A. Instead, the term “each” only implies that a member (of some of the members), in a singular form, is associated with an element A. In claims, the use of a singular form of a noun may imply at least one element even though a plural form is not used.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights.

1. A system comprising:
an offline storage configured to store a private cryptographic key that corresponds to a public cryptographic key that corresponds to a blockchain address of a blockchain; and
a computing device comprising memory and one or more processors, the memory storing executable instructions, wherein the instructions, when executed by the one or more processors, cause the one or more processors to:
connect temporarily to the offline storage to generate one or more pre-authorized transaction requests using the private cryptographic key stored in the offline storage;
disconnect the computing device from the offline storage; and
store the one or more pre-authorized transaction requests in the computing device, wherein the one or more pre-authorized transaction requests include pre-determined parameters such that the one or more pre-authorized transaction requests are broadcastable to the blockchain without further retrieving the private cryptographic key stored in the disconnected storage.

2. The system of claim 1, wherein the one or more pre-authorized transaction requests comprises a staking request to stake a predefined quantity of a blockchain unit to the blockchain.

3. The system of claim 1, wherein the pre-determined parameters include (1) a nonce that is a counter specific to the blockchain address, (2) a recipient address, and (3) a predefined quantity of a blockchain unit.

4. The system of claim 1, wherein the one or more pre-authorized transaction requests comprises an unstaking request that requests a quantity of blockchain unit be returned to the blockchain address corresponding to the public cryptographic key.

5. The system of claim 1, wherein the offline storage is part of an offline multi-party computation node.

6. The system of claim 1, wherein at least one of the pre-authorized transaction requests is separated into multiple shards that are stored in multi-party computation nodes.

7. The system of claim 1, wherein at least one of the pre-authorized transaction requests is stored by the computing device in an encrypted form.

8. The system of claim 1, wherein the offline storage is disconnected permanently from the Internet.

9. The system of claim 1, wherein generating one or more pre-authorized transaction requests comprise:
generating two or more alternative versions of transaction requests that correspond to a same nonce.

10. The system of claim 1, further comprising:
a blockchain node configured to receive a quantity of blockchain unit and broadcast, in response to receiving the quantity, one of the pre-authorized transaction requests to the blockchain without further retrieving the private cryptographic key for signing.

11. A computer-implemented method, comprising:
storing, in an offline storage, a private cryptographic key that corresponds to a public cryptographic key that corresponds to a blockchain address of a blockchain;
connecting temporarily to the offline storage to generate one or more pre-authorized transaction requests using the private cryptographic key stored in the offline storage;
disconnecting from the offline storage; and
storing the one or more pre-authorized transaction requests in the computing device, wherein the one or more pre-authorized transaction requests include pre-determined parameters such that the one or more pre-authorized transaction requests are broadcastable to the blockchain without further retrieving the private cryptographic key stored in the disconnected storage.

12. The computer-implemented method of claim 11, wherein the one or more pre-authorized transaction requests comprises a staking request to stake a predefined quantity of a blockchain unit to the blockchain.

13. The computer-implemented method of claim 11, wherein the pre-determined parameters include (1) a nonce that is a counter specific to the blockchain address, (2) a recipient address, and (3) a predefined quantity of a blockchain unit.

14. The computer-implemented method of claim 11, wherein the one or more pre-authorized transaction requests comprises an unstaking request that requests a quantity of blockchain unit be returned to the blockchain address corresponding to the public cryptographic key.

15. The computer-implemented method of claim 11, wherein the offline storage is part of an offline multi-party computation node.

16. The computer-implemented method of claim 11, wherein at least one of the pre-authorized transaction requests is separated into multiple shards that are stored in multi-party computation nodes.

17. The computer-implemented method of claim 11, wherein at least one of the pre-authorized transaction requests is stored by the computing device in an encrypted form.

18. The computer-implemented method of claim 11, wherein the offline storage is disconnected permanently from the Internet.

19. The computer-implemented method of claim 11, wherein generating one or more pre-authorized transaction requests comprise:
generating two or more alternative versions of transaction requests that correspond to a same nonce.

20. A non-transitory computer-readable medium configured to store code comprising executable instructions, wherein the instructions, when executed by one or more processors, cause the one or more processors to::
connect temporarily to an offline storage to generate one or more pre-authorized transaction requests using a private cryptographic key stored in the offline storage, the private cryptographic key corresponding to a public cryptographic key that corresponds to a blockchain address of a blockchain;
disconnect from the offline storage; and
store the one or more pre-authorized transaction requests in the computing device, wherein the one or more pre-authorized transaction requests include pre-determined parameters such that the one or more pre-authorized transaction requests are broadcastable to the blockchain without further retrieving the private cryptographic key stored in the disconnected storage.
